(19) United States
(12) Patent Application Publication
(10) Pub. No.: US 2025/0065343 A1
(43) Pub. Date: Feb. 27, 2025

(54) SYSTEM, COMPUTING DEVICE, AND METHOD FOR BALANCING CENTRIFUGE

(71) Applicant: Beckman Coulter, Inc., Brea, CA (US)

(72) Inventors: Paul H. Kraght, Brea, CA (US); Richard L. Situ, Brea, CA (US); Vinh T. Tran, Brea, CA (US); William M. Robins, Brea, CA (US); Pawel L. Osial, Brea, CA (US); Jonathan T. Laird, Brea, CA (US)

(21) Appl. No.: 18/723,584

(22) PCT Filed: Dec. 29, 2022
(86) PCT No.: PCT/US2022/082539

§ 371 Date: Jun. 24, 2024

Related U.S. Application Data
(60) Provisional application No. 63/295,517, filed on Dec. 31, 2021.

(51) Int. Cl. B04B 9/14; B04B 5/04; B04B 7/02; B04B 13/00

(52) U.S. Cl. CPC B04B 9/14; B04B 5/0414; B04B 13/00; B04B 2007/025

(57) ABSTRACT

A tube from a plurality of tubes from a tube rack configured to removably hold the plurality of tubes are removed from a tube rack. A weight of the tube which has been removed from the tube rack is determined. A balancing parameter of the tube is determined by a computing device. An estimated balancing parameter of each of a plurality of remaining tubes from the plurality of tubes in the tube rack is determined. A corresponding rotor position from a plurality of rotor positions within the rotor for the tube is determined by the computing device based at least on the balancing parameter of the tube, the balancing parameters of previously placed tubes from the plurality of tubes placed within the rotor and the estimated balancing parameter of each of the plurality of remaining tubes. The transport unit places the tube in the corresponding rotor position within the rotor.

### CROSS-REFERENCE TO RELATED APPLICATIONS

This application claims the benefit of U.S. Provisional Appl. Ser. No. 63/295,517, filed Dec. 31, 2021, which is incorporated by reference as if fully set forth herein.

### FIELD

The present disclosure relates to a method for balancing a centrifuge and a system comprising a computing device for performing the method. The present disclosure further relates to an automated analyzer comprising the system.

### BACKGROUND

Automated analyzers are well known in the art and are generally used for automated or semi-automated analysis of patient samples, such as blood, urine, spinal fluid, and the like. In some cases, a centrifugation process may be required to separate constituents of the patient samples for testing and analyzing the patient sample. For such requirements, some automated analyzers may further comprise centrifuge systems. The automated analyzers may automate the centrifugation process for testing and analyzing the patient sample, for example, in clinical laboratories.

The patient samples are generally provided to the automated analyzers in sample tubes. The sample tubes may be available in different shapes and/or sizes. For example, the different shapes and/or sizes of the sample tubes may be suitable for containing different types and/or quantities of the patient samples.

The sample tubes are transferred to the centrifuge systems for the centrifugation process. Specifically, the sample tubes are transferred to rotors of the centrifuge systems for the centrifugation process.

The sample tubes are automatically transferred to the rotors of the centrifuge systems of the automated analyzers to ensure maximum automation and minimum human intervention of a user (for example, a laboratory operator, a technician, or a scientist). However, a centrifuge imbalance may occur when different types of the sample tubes and/or the sample tubes containing different quantities of the patient samples are automatically placed within the rotors of the centrifuge systems. In other words, the rotors of the centrifuge systems may not be well-balanced when different types of the sample tubes and/or the sample tubes containing different quantities of the patient samples are automatically placed within the rotors. Consequently, when the rotors of the centrifuge systems are not well-balanced during the centrifugation process, the centrifugation process may be automatically halted by the automated analyzers. This may negatively affect a throughput of the centrifuge systems and, in turn, a throughput of the automated analyzers. This may further disrupt a workflow of the automated analyzers. Further, in such cases, human intervention may eventually be required for balancing the rotors and/or resuming the centrifugation process. Balancing the rotors by the user may be time-consuming, which may further negatively affect the throughput of the centrifuge systems and/or the throughput of the automated analyzers. Further, such automated analyzers may require constant observation and the user may have to wait till completion of the centrifugation process. This may be undesirable for the user as some of the centrifugation processes may take a long duration of time to complete.

In addition, when the rotors of the centrifuge systems are not well-balanced during the centrifugation process, there may be malfunctions in the centrifuge systems (for example, breakdowns) and the centrifugation process may also be noisy.

### BRIEF SUMMARY

Examples described herein involve a method for balancing a centrifuge having a rotor. The method comprises removing, by a transport unit, a tube from a plurality of tubes from a tube rack configured to removably hold the plurality of tubes. A weight of the tube which has been removed from the tube rack is determined. A balancing parameter of the tube is determined by a computing device. An estimated balancing parameter of each of a plurality of remaining tubes from the plurality of tubes in the tube rack is determined. A corresponding rotor position from a plurality of rotor positions within the rotor for the tube is determined by the computing device based at least on the balancing parameter of the tube, the balancing parameters of previously placed tubes from the plurality of tubes placed within the rotor and the estimated balancing parameter of each of the plurality of remaining tubes. The transport unit places the tube in the corresponding rotor position within the rotor. A system comprising a computing device and a transport unit may perform the method above. An automated analyzer may include the system and may further comprise a centrifuge comprising the rotor. The rotor comprises the plurality of rotor positions.

A computing device for balancing a centrifuge has a rotor and comprises at least one memory configured to store instructions and at least one processor capable of executing the instructions to perform controlling the transport unit to remove a tube from a plurality of tubes from a tube rack configured to removably hold the plurality of tubes. A weight of the tube which has been removed from the tube rack is determined. A balancing parameter of the tube is determined by a computing device. An estimated balancing parameter of each of a plurality of remaining tubes from the plurality of tubes in the tube rack is determined. A corresponding rotor position from a plurality of rotor positions within the rotor for the tube is determined by the computing device based at least on the balancing parameter of the tube, the balancing parameters of previously placed tubes from the plurality of tubes placed within the rotor and the estimated balancing parameter of each of the plurality of remaining tubes. The transport unit is controlled to place the tube in the corresponding rotor position within the rotor.

A variety of additional aspects will be set forth in the description that follows. These aspects can relate to individual features and to combinations of features. It is to be understood that both the foregoing summary and the following detailed description are exemplary and explanatory only and are not restrictive of the broad concepts upon which the embodiments disclosed herein are based.

### BRIEF DESCRIPTION OF THE FIGURES

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic block diagram of an automated analyzer, according to an embodiment of the present disclosure;

FIG. 2A is a schematic top view of the automated analyzer, according to an embodiment of the present disclosure;

FIG. 2B is a schematic front view of the automated analyzer, according to an embodiment of the present disclosure;

FIG. 3 is a schematic top view of centrifuges of the automated analyzer in different configurations, according to an embodiment of the present disclosure;

FIG. 4 is a schematic perspective view of a transport unit of the automated analyzer, according to an embodiment of the present disclosure;

FIGS. 5A, 5B, and 5C are schematic perspective, front, and side views, respectively, of a pick-and-place device of the transport unit, according to an embodiment of the present disclosure;

FIGS. 6A to 6F are schematic front, top, and perspective views of a tube rack, according to embodiments of the present disclosure;

FIG. 7 is a schematic side view of a tube for containing a biological sample, according to an embodiment of the present disclosure;

FIGS. 8A to 8G are schematic block diagrams illustrating methods for balancing the centrifuge, each according to an embodiment of the present disclosure;

FIGS. 9A to 9D are schematic top views of different configurations of the centrifuge, according to another embodiment of the present disclosure;

FIGS. 10A to 10C are schematic top views of different configurations of the centrifuge, according to yet another embodiment of the present disclosure;

FIG. 11 is a schematic top view of a different configuration of the centrifuge, according to another embodiment of the present disclosure;

FIG. 12 is an exemplary plot depicting a magnitude of an imbalance vector after placement of different tubes;

FIG. 13 is a flowchart illustrating a method for balancing the centrifuge, according to an embodiment of the present disclosure;

FIG. 14A is an exemplary plot depicting a probability distribution of a difference between a remaining weight of a plurality of remaining tubes and a weight of one of the plurality of remaining tubes;

FIG. 14B is an exemplary plot depicting a probability distribution of the weight of the one of the plurality of remaining tubes;

FIG. 14C is an exemplary plot depicting a usable portion of the probability distribution of the weight of the one of the plurality of remaining tubes based on lower and upper weight limits of the one of the plurality of remaining tubes;

FIG. 14D is an exemplary plot depicting a cumulative distribution of the weight of the one of the plurality of remaining tubes;

FIG. 14E is an exemplary plot depicting the cumulative distribution of the weight of the one of the plurality of remaining tubes comprising probability fractions and corresponding fractiles;

FIG. 15 is an exemplary plot depicting performances of different methods for balancing the centrifuge;

FIG. 16 is an exemplary plot depicting different resulting magnitudes of imbalance vectors when different number of tubes having different tube types are placed on the centrifuge;

FIG. 17 is an exemplary plot that shows the results of applying various algorithms to sets of randomly-chosen tube weights; and

FIG. 18 is an exemplary plot depicting imbalance vectors when different number of tubes having different tube types are placed on the centrifuge.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

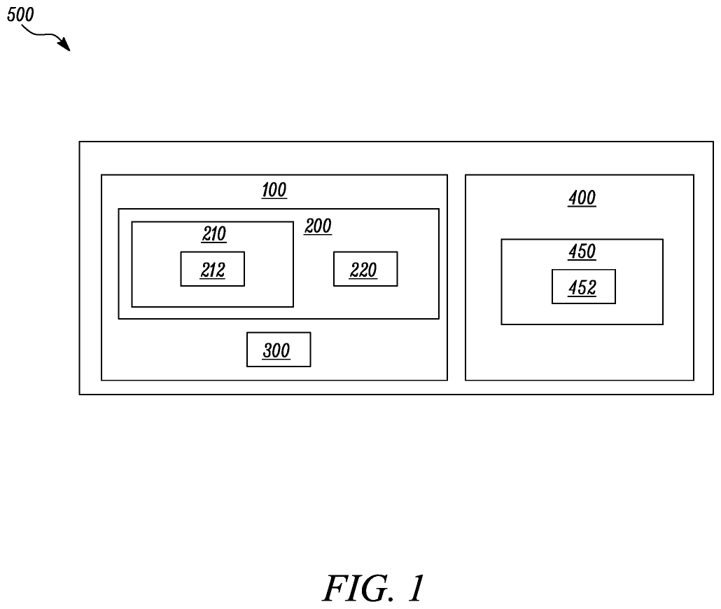

Referring now to Figures, FIG. 1 illustrates a schematic block diagram of an automated analyzer 500, according to an embodiment of the present disclosure. The automated analyzer 500 may be used by an operator. The automated analyzer 500 may conduct qualitative and/or quantitative analysis on one or more chemical components contained in a biological sample, or upon biologically derived substances contained in the biological sample, such as blood, urine, spinal fluid, and the like.

In some cases, the biological sample may require sample preparation before the qualitative and/or quantitative analysis can be performed. The sample preparation may comprise a centrifugation process. The centrifugation process may separate the biological sample into its constituent components for isolation or analysis of the components.

The automated analyzer 500 comprises a system 100 and a centrifuge 400. The centrifuge 400 may carry out the centrifugation process. The centrifuge 400 comprises a rotor 450. The rotor 450 comprises a plurality of rotor positions 452.

The system 100 comprises a computing device 200. The computing device 200 is used for balancing the centrifuge 400 having the rotor 450. The system 100 further comprises a transport unit 300 controlled by the computing device 200.

The computing device 200 comprises at least one memory 210 configured to store instructions 212. The computing device 200 further comprises at least one processor 220 capable of executing the instructions 212. When the instructions 212 are executed by the at least one processor 220, the instructions 212 cause the at least one processor 220 to perform one or more of the actions, operations, methods, or functions described herein.

In some embodiments, the at least one memory 210 may comprise a hard disk that magnetically or electronically stores the instructions 212 and electrically loads various programs related to a process from the hard disk when the at least one processor 220 executes the instructions 212. The at least one memory 210 may comprise an auxiliary storage device that can read information stored in a storage medium, such as a CD-ROM, a DVD-ROM, or the like.

In some embodiments, the at least one processor 220 may comprise any suitable data processor for processing data. For example, the at least one processor 220 may comprise a microprocessor, a microcontroller, a computer, or other suitable devices that control operation of devices and execute programs. Various other examples of the at least one processor 220 comprise central processing units (“CPUs”), microcontrollers, programmable logic devices, field programmable gate arrays, digital signal processing (“DSP”) devices, and the like. The at least one processor 220 may comprise any general variety device such as a reduced instruction set computing (“RISC”) device, a complex instruction set computing (“CISC”) device, or a specially designed processing device, such as an application-specific integrated circuit (“ASIC”) device.

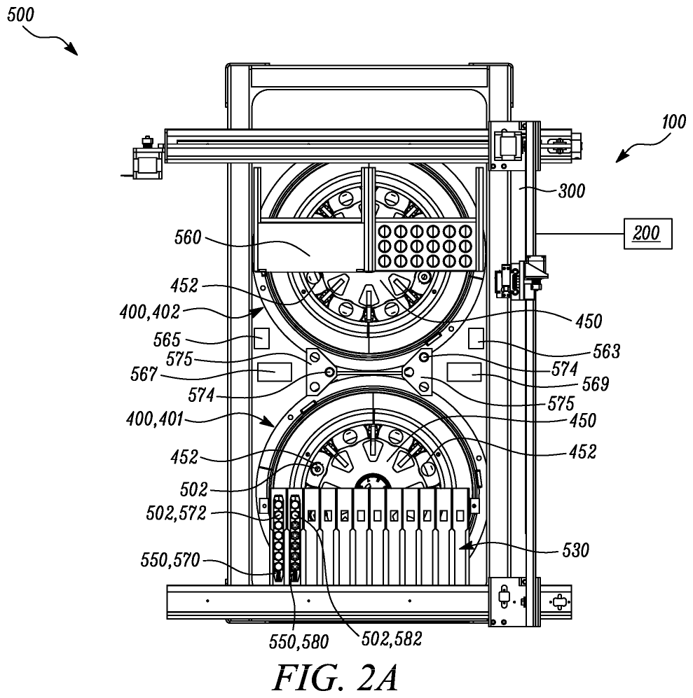

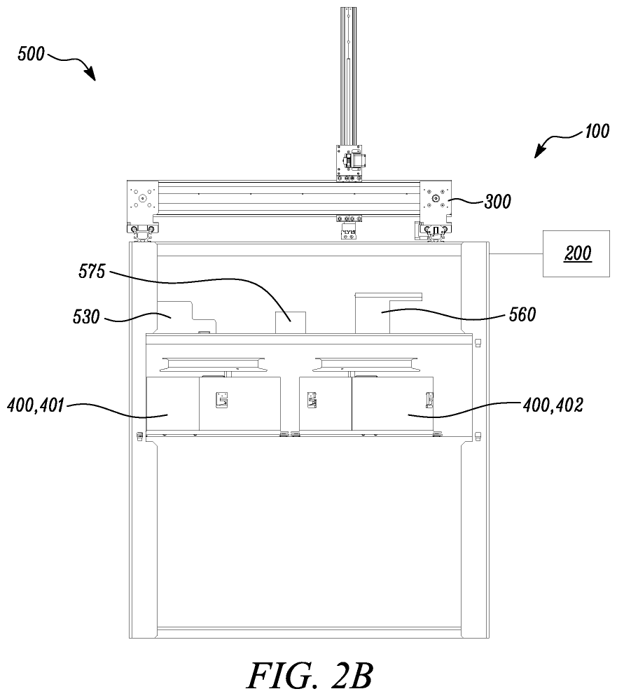

FIG. 2A illustrates a schematic top view of the automated analyzer 500, according to an embodiment of the present disclosure. FIG. 2B illustrates a schematic front view of the automated analyzer 500, according to an embodiment of the present disclosure. Some components of the automated analyzer 500 are not shown for illustrative purposes.

Referring to FIGS. 2A and 2B, the automated analyzer 500 may conduct qualitative and quantitative analysis on one or more chemical components contained in the biological sample. The biological samples are delivered to the automated analyzer 500 via a plurality of tubes 502. The plurality of tubes 502 may be interchangeably referred to as “the tubes 502”.

In the illustrated embodiment of FIG. 2A, the automated analyzer 500 comprises two centrifuges 400, i.e., a centrifuge 401 and a centrifuge 402. However, the automated analyzer 500 may comprise any number of the centrifuges 400, as per desired application attributes. Each of the centrifuges 401, 402 comprises the rotor 450 comprising the plurality of rotor positions 452.

In some embodiments, the automated analyzer 500 may further comprise a load area 530. The load area 530 may be a point at which the tubes 502 are introduced to the automated analyzer 500. The load area 530 may be configured to removably hold one or more tube racks 550. In the illustrated embodiment of FIG. 2A, the load area 530 is configured to hold twelve tube racks 550 and currently comprises two tube racks, i.e., a tube rack 570 and another tube rack 580. In some other cases, the load area 530 may be configured to hold any number of tube racks, as per desired application attributes.

The tube racks 550 are configured to removably hold the tubes 502. In the illustrated embodiment of FIG. 2A, the tube rack 570 removably holds a plurality of tubes 572 and the other tube rack 580 removably holds one or more tubes 582. While the term “tube rack” is used herein to describe an apparatus configured to removably hold a plurality of tubes, it is to be understood that any type of holder may be used. Similarly, “tube” as described herein may encompass any type of sample holder. Therefore, the “tube rack” may be any type of sample carrier.

In some embodiments, the load area 530 may be manually accessible. For example, the operator may manually place and remove the tube racks 550 to or from the load area 530.

In some embodiments, the load area 530 may further be accessible by the transport unit 300. Specifically, the tube racks 550 may further be accessible by the transport unit 300. For example, the transport unit 300 may automatically place or remove the plurality of tubes 572 on or from the tube rack 570.

In some embodiments, the automated analyzer 500 may further comprise one or more dummy tube racks 575. The one or more dummy tube racks 575 may be configured to removably hold at least one dummy tube 574. In the illustrated embodiment of FIG. 2A, the automated analyzer 500 comprises two dummy tube racks 575, each configured to removably hold three dummy tubes 574. In the illustrated embodiment of FIG. 2A, each of the dummy tube racks 575 comprise one dummy tube 574. In some embodiments, the at least one dummy tube 574 may be one of the tubes 502 that is loaded with a predetermined weight. In some cases, the at least one dummy tube 574 may be filled with a predetermined volume of a liquid, such as water. The predetermined weight and/or the predetermined volume may be stored in the at least one memory 210 of the computing device 200. Further, a tube type of the tube of the at least one dummy tube 574 may also be stored in the at least one memory 210 (shown in FIG. 1) of the computing device 200.

In some embodiments, the automated analyzer 500 may further comprise a calibration/quality control module 560. The calibration/quality control module 560 may be temperature controlled. The calibration/quality control module 560 may be configured to removably hold and store calibrator and/or quality control material. The calibration/quality control module 560 may be temperature controlled in order to improve and/or ensure the shelf life of the calibrator and/or quality control material. The calibrator and/or quality control material may be transferred to the calibration/quality control module 560 from the load area 530 via the transport unit 300 for storage. The transport unit 300 may further transfer the calibrator and/or quality control material from the calibration/quality control module 560 to an analyzer (not shown) of the automated analyzer 500 when required.

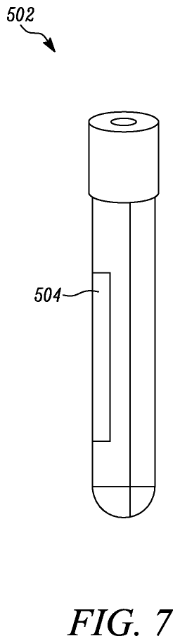

In some embodiments, one or more of the tubes 502 may comprise one or more identifiers 504 (shown in FIG. 7). In some embodiments, the automated analyzer 500 may further comprise a reading unit 563. The reading unit 563 may be configured to read the one or more identifiers 504 of the one or more of the tubes 502. The reading unit 563 may comprise a barcode reader, a QR code reader, or an RFID reader, which may read out information from the one or more identifiers 504 disposed on the one or more of the tubes 502. In some embodiments, the computing device 200 may store the information in the at least one memory 210 (shown in FIG. 1) of the computing device 200. In some other embodiments, the reading unit 563 may comprise a digital camera which records a digital image of the tubes 502 and compares the digital image to corresponding information stored in the at least one memory 210 in order to identify the types of the tubes 502. In some cases, the reading unit 563 may further determine a presence/absence of a cap (not shown) on one or more of the tubes 502.

In some embodiments, the automated analyzer 500 may further comprise a mixer 565. The mixer 565 may be used to mix the biological sample, for example, blood. In some embodiments, the automated analyzer 500 may further comprise a decap module 567 and a recap module 569. The decap module 567 may remove the cap from one or more of the tubes 502. In some examples, the decap module 567 may remove a cap from a tube 502 from the plurality of tubes 502 prior to transferring the tube 502 to the analyzer. In some examples, the decap module 567 may remove a cap from a tube 502 from the plurality of tubes 502 after the centrifugation process. The recap module 569 may place a cap on one or more of the tubes 502. For example, the recap module 569 may place a cap on a tube 502 after the biological sample in the tube 502 has been analyzed for storage. In some cases, the biological sample may be required for future analysis. The recap module 569 may further comprise a cap sorter (not shown), so that the recap module 569 may place a cap of a suitable shape and/or size on the tube 502. In some cases, the caps may be specific to the tube 502 and the cap sorter may identify the specific cap of the tube 502 for placing on the tube 502.

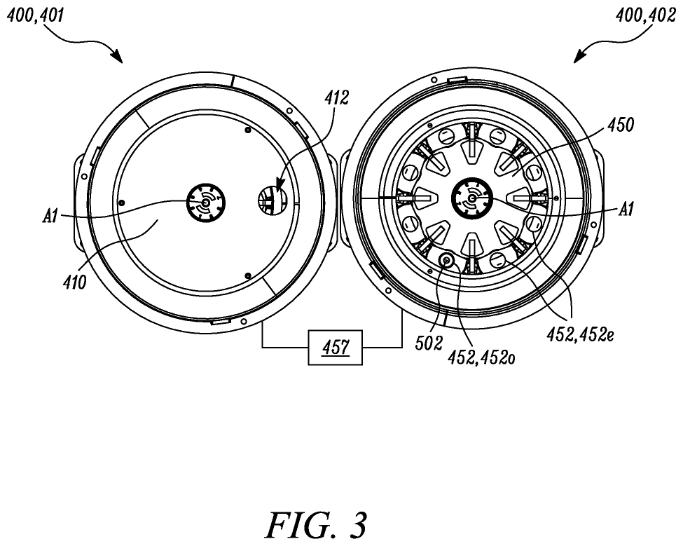

FIG. 3 illustrates a schematic top view of the centrifuges 400 of the automated analyzer 500 (shown in FIGS. 2A and 2B) in different configurations, according to an embodiment of the present disclosure. Specifically, FIG. 3 illustrates the centrifuge 401 in a closed configuration and the centrifuge 402 in an open configuration.

The centrifuge 401 and the centrifuge 402 may be substantially similar to each other. As discussed above, each of the centrifuges 401, 402 comprises the rotor 450 comprising the plurality of rotor positions 452. In the illustrated embodiment of FIG. 3, each of the centrifuges 401, 402 comprises eight rotor positions 452. Further, each of the plurality of rotor positions 452 is configured to removably hold one of the tubes 502. Therefore, each of the centrifuges 401, 402 is configured to removably hold eight of the tubes 502. In some other embodiments, each of the centrifuges 401, 402 may be configured to removably hold any number of the tubes 502, as per desired application attributes. Further, in some other embodiments, each of the plurality of rotor positions 452 may be configured to removably hold any number of the tubes 502, as per desired application attributes. For example, each of the plurality of rotor positions 452 may be configured to hold two of the tubes 502. In some embodiments, the centrifuges 401, 402 may be configured to removably hold different numbers of the tubes 502.

In the illustrated embodiment of FIG. 3, the centrifuge 402 is removably holding one tube 502. Specifically, one of the plurality of rotor positions 452 is removably holding the one tube 502. Further, the remaining seven of the plurality of rotor positions 452 are empty. Therefore, the remaining seven of the plurality of rotor positions 452 are available to receive and removably hold the tubes 502. The centrifuge 400 comprises occupied rotor positions 4520 from the plurality of rotor positions 452 and empty rotor positions 452e from the plurality of rotor positions 452. Specifically, the rotor positions 452 removably holding the tubes 502 may be referred to as the occupied rotor positions 4520 and the rotor positions 452 not holding the tubes 502 may be referred to as the empty rotor positions 452e.

In some embodiments, the plurality of rotor positions 452 is arranged in a circular manner. The centrifuge 400 may be configured to rotate about a centrifuge axis A1. Further, a centrifuge drive mechanism (not shown) may selectively rotate the centrifuge 400 about the centrifuge axis A1. The centrifuge drive mechanism may be controlled by the computing device 200 (shown in FIG. 1) of the system 100 (shown in FIG. 1). The centrifuge 400 may be configured to rotate about the centrifuge axis A1 in a clockwise and/or in an anticlockwise direction. The centrifuge drive mechanism may comprise any conventional mechanism well known to those skilled in the art. For example, the centrifuge drive mechanism may comprise a servo or stepper motor coupled to the centrifuge 400 through a system of belts, gears, or other similar arrangements known in the art. Each tube 502 when placed within the rotor 450 results in a moment with respect to the centrifuge axis A1.

The centrifuge 400 may further comprise a high-speed motor-driven spindle. The spindle may be driven at a selected rotational speed (rotor speed) which may be as high as from about 1000 revolutions per minute (RPM) up to about 100,000 RPM. According to some examples, the rotor speed is in a range of about 1,500 RPM to about 10,000 RPM. In some embodiments, the computing device 200 may stop the spindle at selected positions for automated placement and removal of the tubes 502.

In some embodiments, as a safety feature, the centrifuge 400 comprises a lid 410. The lid 410 may have an open position and a closed position corresponding to the open and closed configurations of the centrifuge 400. The lid 410 may be at least partially removable. In some embodiments, the lid 410 may be a flap and is hingedly attached to the centrifuge 400. In some other embodiments, the lid 410 may be a sliding cover. In some embodiments, the lid 410 may open and close in response to instructions from the computing device 200. In some embodiments, the centrifuge 400 is also temperature controlled.

In some embodiments, the lid 410 comprises an access opening 412 aligned with one or more of the plurality of rotor positions 452. In some embodiments, the system 100 is configured rotate the rotor 450, such that the access opening 412 is at least aligned with a desired rotor position 452. Specifically, the computing device 200 of the system 100 may be configured to selectively rotate the rotor 450 about the centrifuge axis A1, such that the access opening 412 is at least aligned with a desired rotor position 452. In some embodiments, the transport unit 300 (shown in FIGS. 2A and 2B) is configured to access the rotor 450 by moving vertically through the access opening 412 to transfer the tubes 502 to or from the rotor 450.

In some embodiments, the centrifuge 400 may comprise an interlock mechanism 457, such as an electric interlock and/or a mechanical interlock, configured to releasably hold the centrifuge 400 stationary when the lid 410 is in the open position and allow the centrifuge 400 to move when the lid 410 is in the closed position. In some embodiments, the interlock mechanism 457 may secure the lid 410 in the closed position during the centrifugation process. The interlock mechanism 457 may comprise various components, such as switches, latches, and so forth. The interlock mechanism 457 may be controlled by the computing device 200 (shown in FIG. 2A). This may restrict access of the operator to the centrifuge 400 when the centrifuge 400 is rotating about the centrifuge axis A1 and may ensure that the operator is not injured by the movement of the centrifuge 400. Further, this may also prevent any damage to the centrifuge 400 and/or the tubes 502 caused by an obstruction during the movement of the centrifuge 400.

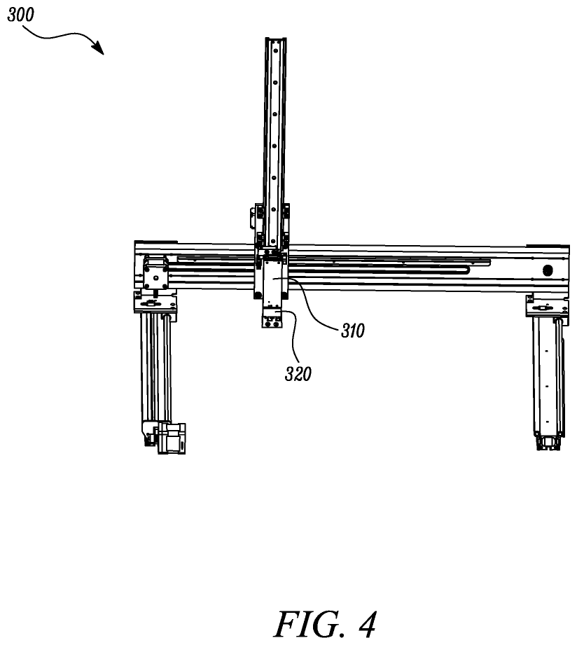

FIG. 4 illustrates a schematic perspective view of the transport unit 300 of the automated analyzer 500 (shown in FIGS. 2A and 2B), according to an embodiment of the present disclosure.

In some embodiments, the transport unit 300 comprises a pick-and-place device 310. In some embodiments, the pick-and-place device 310 comprising a gripper 320 is configured to removably engage at least one of the tubes 502 (shown in FIG. 2A) and thereby place the at least one of the tubes 502 within the rotor 450 (shown in FIG. 3).

The transport unit 300 is configured to automatically transfer the at least one of the tubes 502 at least between the tube rack 550 (shown in FIG. 2A) and the rotor 450. Specifically, the gripper 320 of the transport unit 300 is configured to removably engage the at least one of the tubes 502 and thereby automatically transfer the at least one of the tubes 502 at least between the tube rack 550 (shown in FIG. 2A) and the rotor 450. In some embodiments, the gripper 320 may further be configured to removably engage at least one of the tube racks 550 and thereby transfer the at least one of the tube racks 550 to or from the load area 530 (shown in FIG. 2A).

In some embodiments, the transport unit 300 may transfer the tubes 502 to and from other components of the automated analyzer 500 (shown in FIG. 2A), such as the analyzer, the decap module 567, the recap module 569, etc.

In the illustrated embodiment of FIG. 4, the transport unit 300 comprises a Cartesian or XYZ gantry. However, in some other embodiments, the transport unit 300 may comprise any other transport mechanism well known to those skilled in the art, as per desired application attributes. For example, the transport unit 300 may additionally or alternatively include a rotary mechanism.

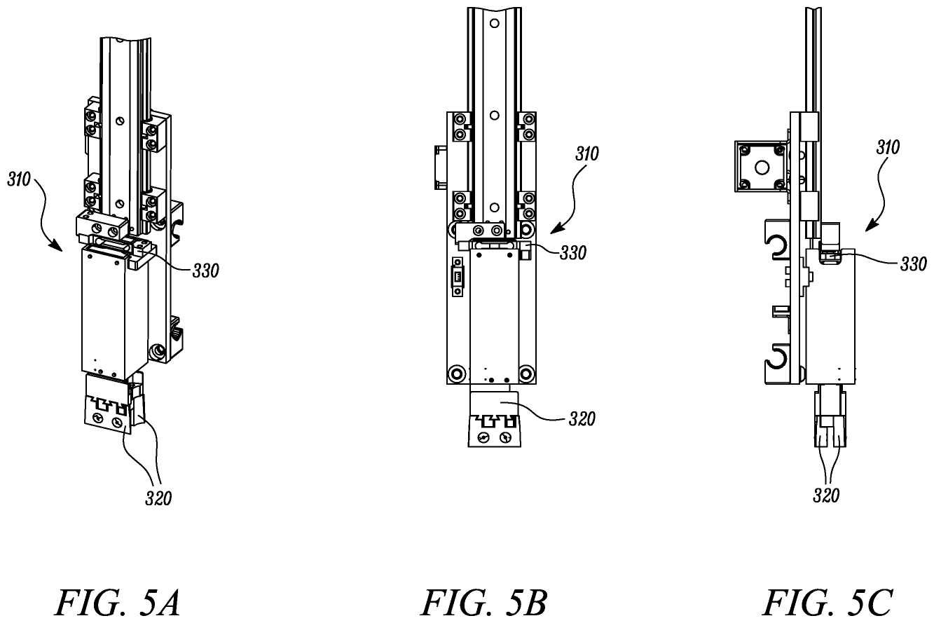

FIGS. 5A, 5B, and 5C illustrate schematic perspective, front, and side views, respectively, of the pick-and-place device 310 of the transport unit 300 (shown in FIG. 4).

In some embodiments, the pick-and-place device 310 comprises at least one sensor 330. In some embodiments, the at least one sensor 330 may be disposed on top of the gripper 320. The at least one sensor 330 may be any sensor suitable to produce a signal indicative of a weight. In some examples, the at least one sensor 330 may be a load cell.

In some embodiments, the at least one sensor 330 may be configured to determine a weight of the at least one of the tubes 502 removably engaged by the gripper 320 of the pick-and-place device 310. In some embodiments, the at least one sensor 330 may be configured to determine a weight of the at least one of the tube racks 550 removably engaged by the gripper 320 of the pick-and-place device 310.

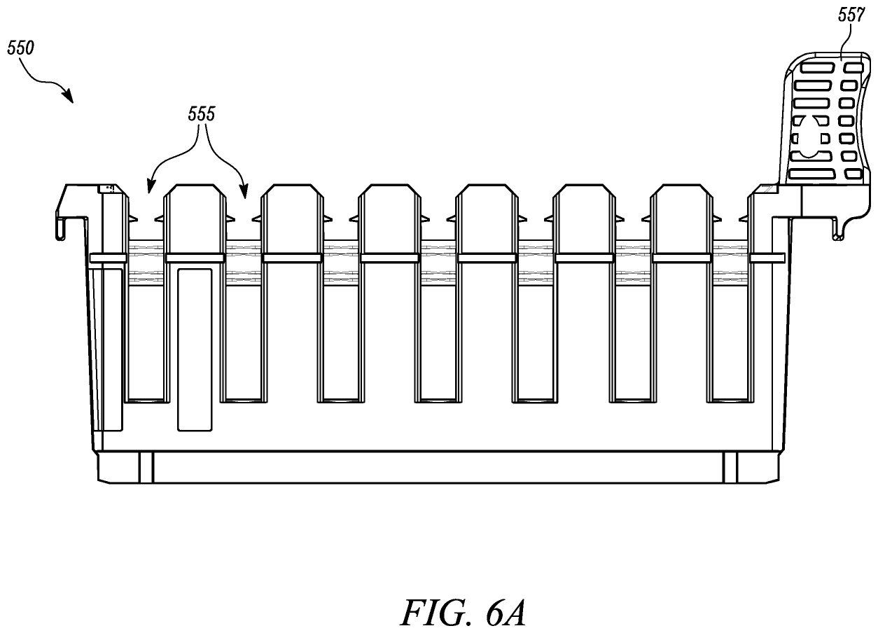

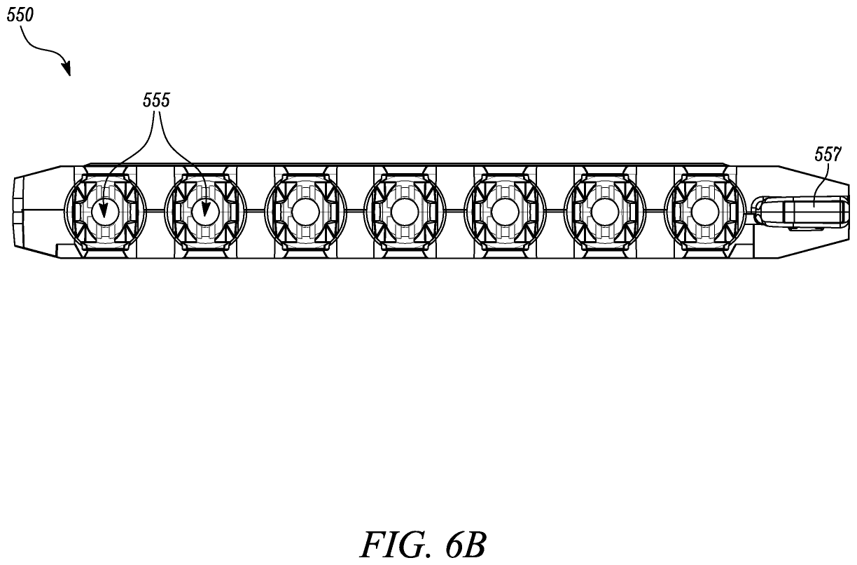

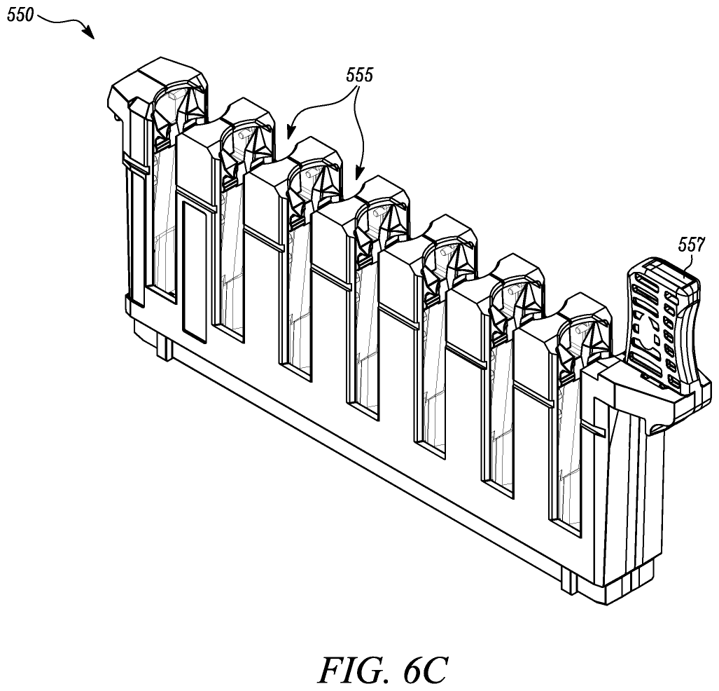

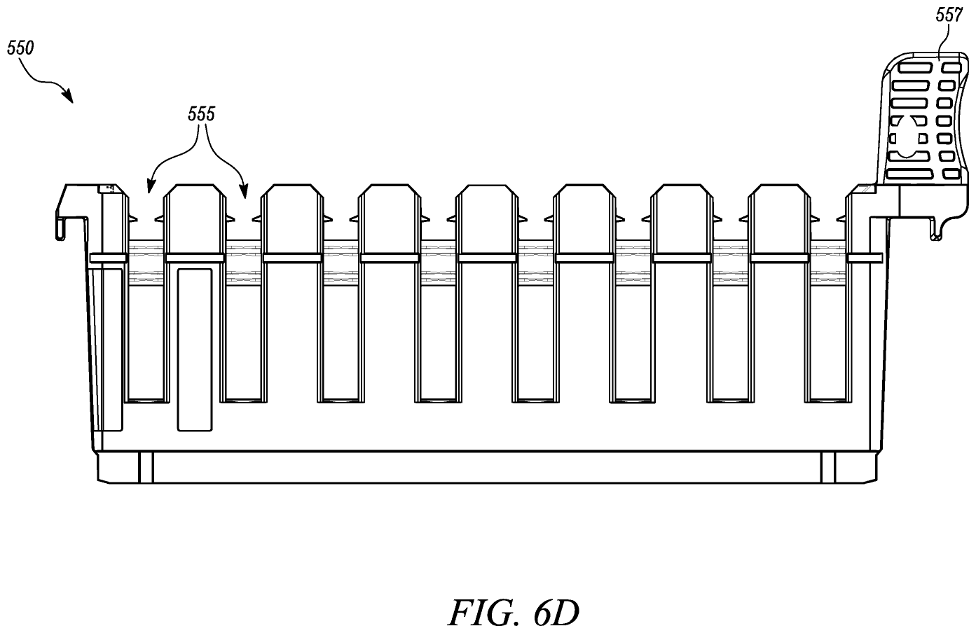

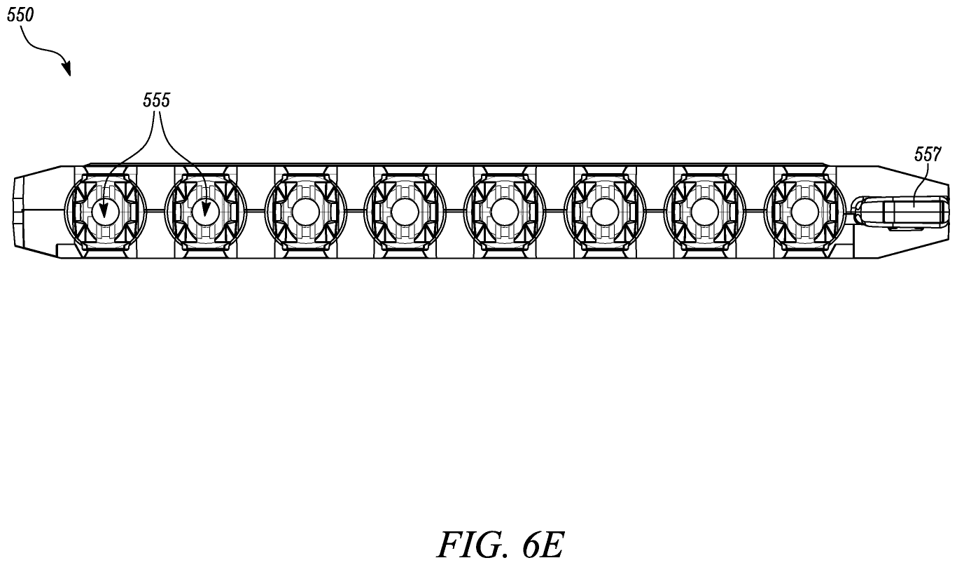

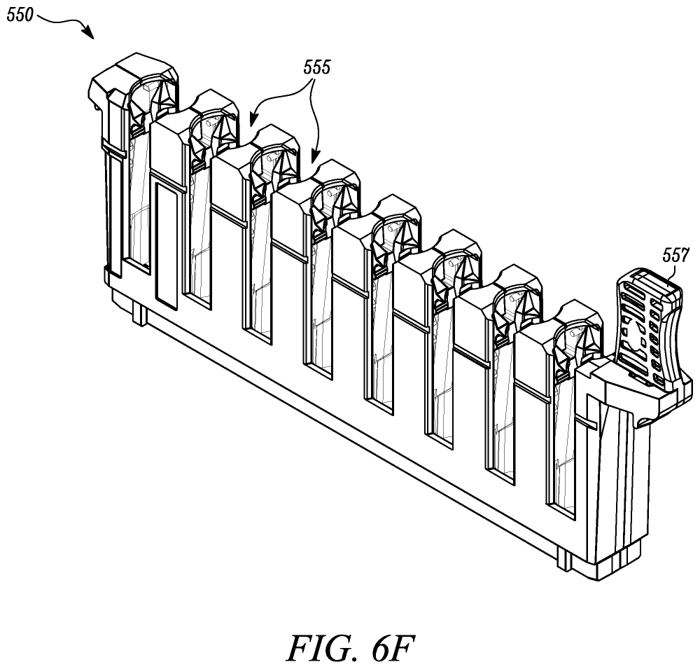

FIGS. 6A, 6B, and 6C are schematic front, top, and perspective views, respectively, of the tube rack 550, according to an embodiment of the present disclosure.

The tube rack 550 comprises a plurality of tube holding positions 555 configured to removably hold the tubes 502. In the illustrated embodiment of FIGS. 6A, 6B, and 6C, the tube rack 550 comprises seven tube holding positions 555. Therefore, the tube rack 550 is configured to removably hold seven of the tubes 502. In some other embodiments, the tube rack 550 is configured to removably hold any number of the tubes 502, as per desired application attributes. The tube rack has an empty weight 505 that defines the weight of the tube rack without any tubes disposed therein.

In some embodiments, the tube rack 550 further comprises a grippable portion 557. In some examples, the operator may manually grip the grippable portion 557 to place or remove the tube racks 550 to or from the load area 530 (shown in FIG. 2A). In some examples, the gripper 320 (shown in FIGS. 5A-5C) may further be configured to removably engage the grippable portion 557 to transfer the tube racks 550 to or from the load area 530.

FIGS. 6D, 6E and 6F are schematic front, top, and perspective views, respectively, of the tube rack 550, according to another embodiment of the present disclosure.

FIG. 7 is a schematic view of one of the tubes 502 for containing the biological sample, according to an embodiment of the present disclosure.

The tubes 502 may be at least partially filled with the biological sample. For example, in some cases, the tube 502 may be fully or partially filled with the biological sample, as per application requirements. In some cases, some of the tubes 502 may comprise lesser biological sample than the other of the tubes 502. In some cases, some of the tubes 502 may comprise a different type of the biological sample than the other of the tubes 502. Therefore, the tubes 502 may have different weights.

Since laboratories typically process the biological samples from different sources, such as different hospitals, testing labs, and doctors' offices, the tubes 502 may comprise different tube types. The tubes 502 comprising different tube types may have different shape, size, height, diameter, etc. Therefore, the tubes 502 may have different weights and dimensions.

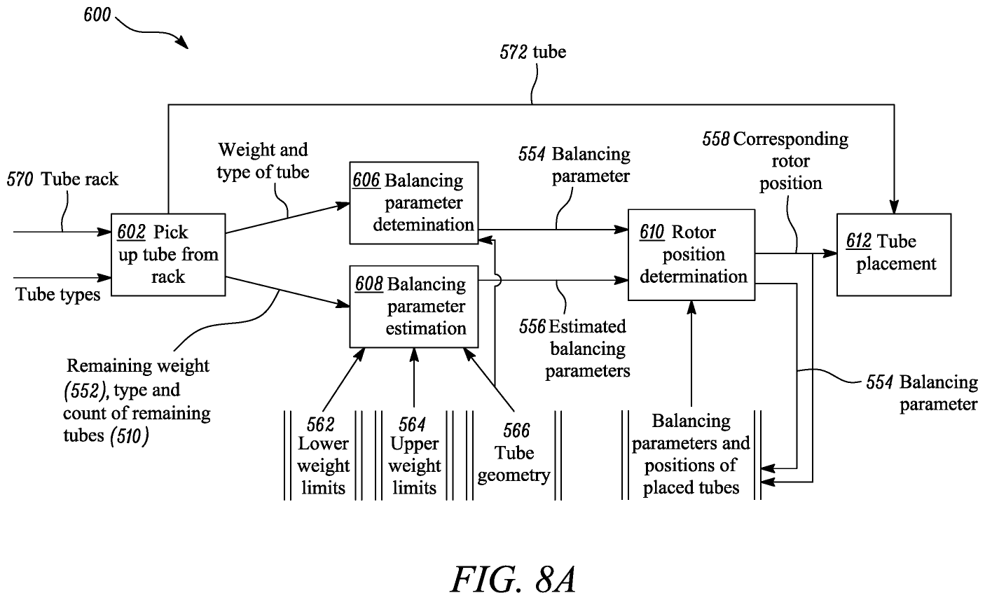

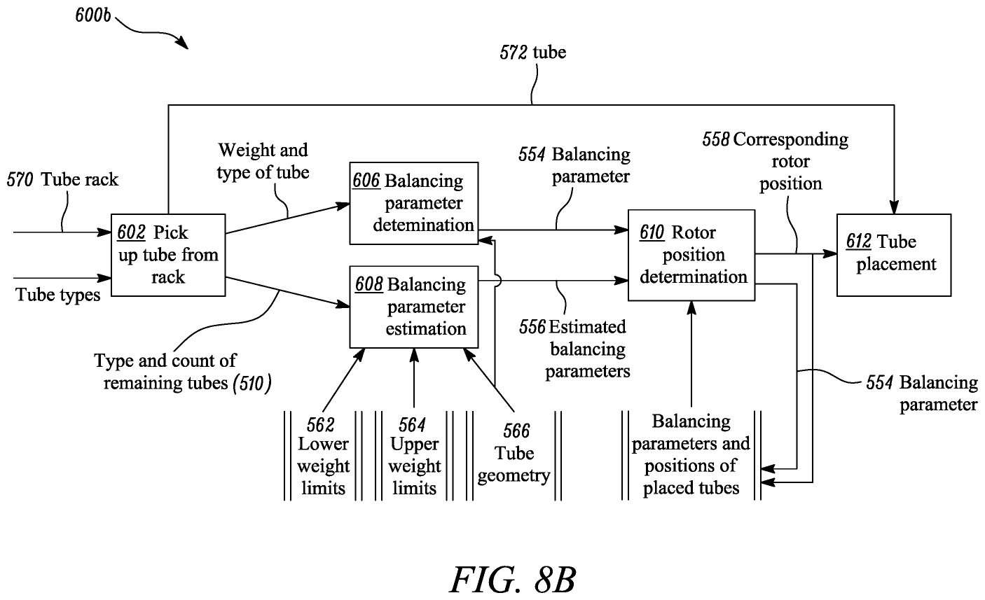

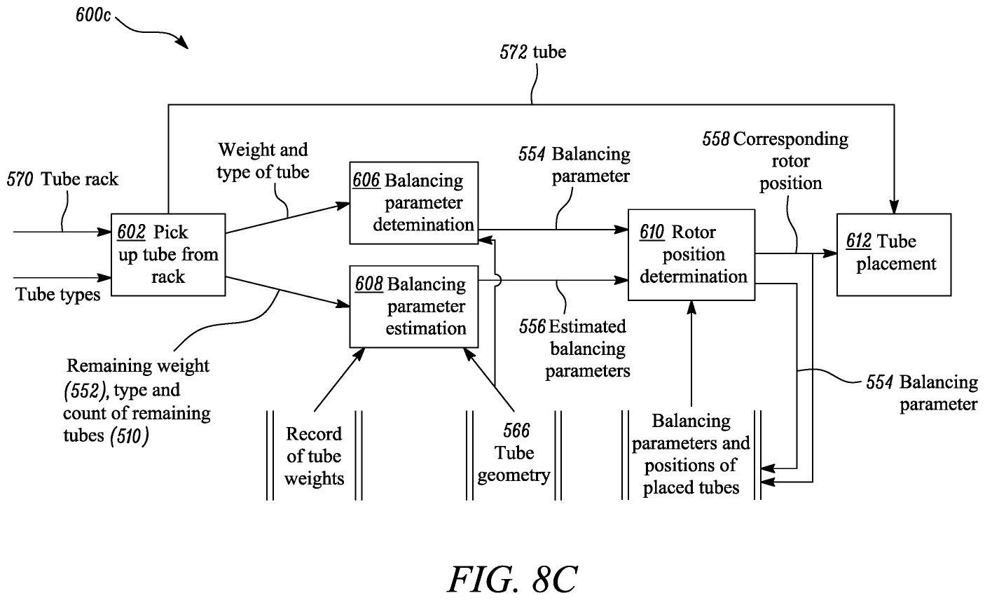

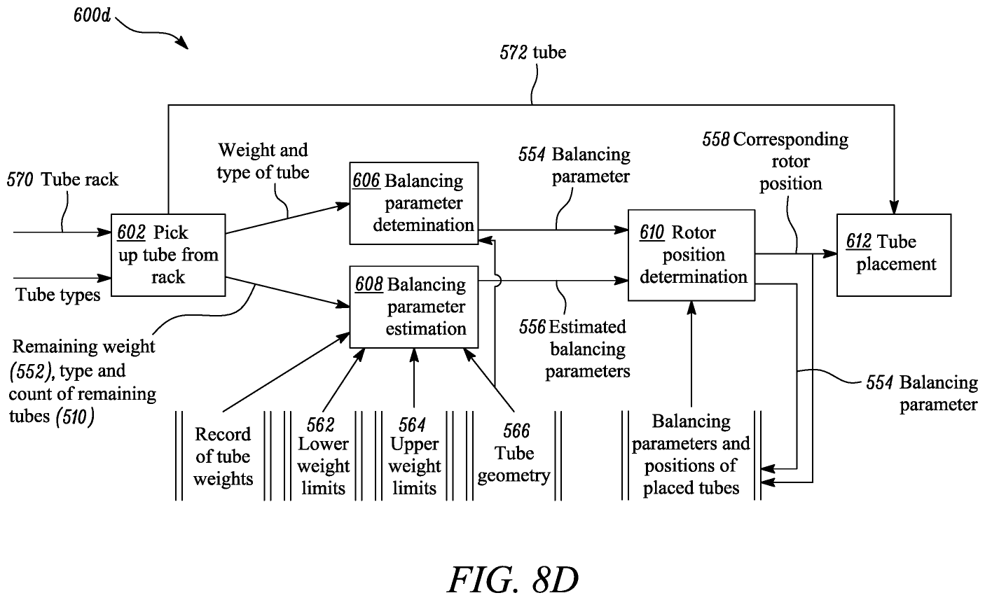

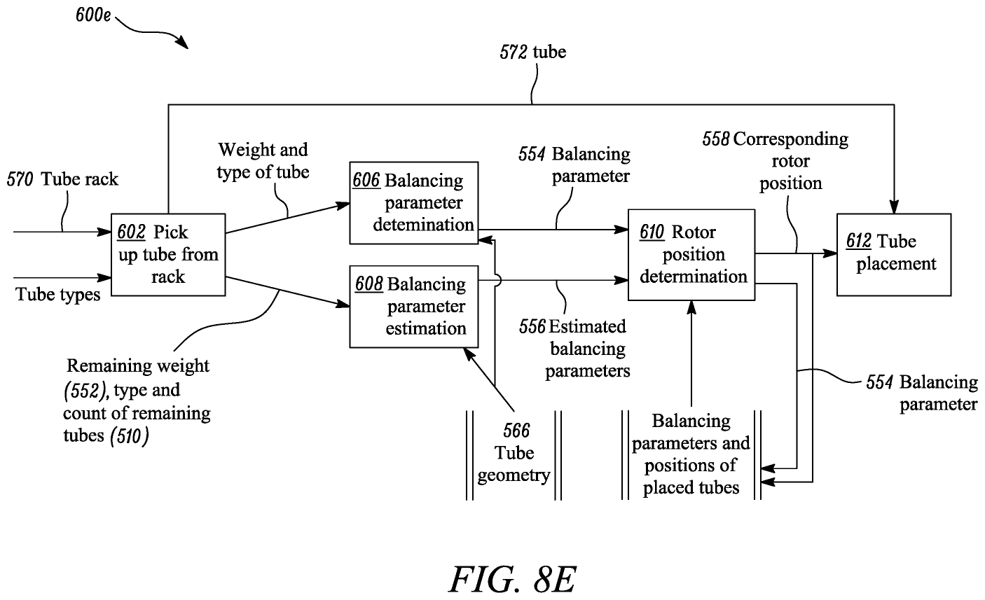

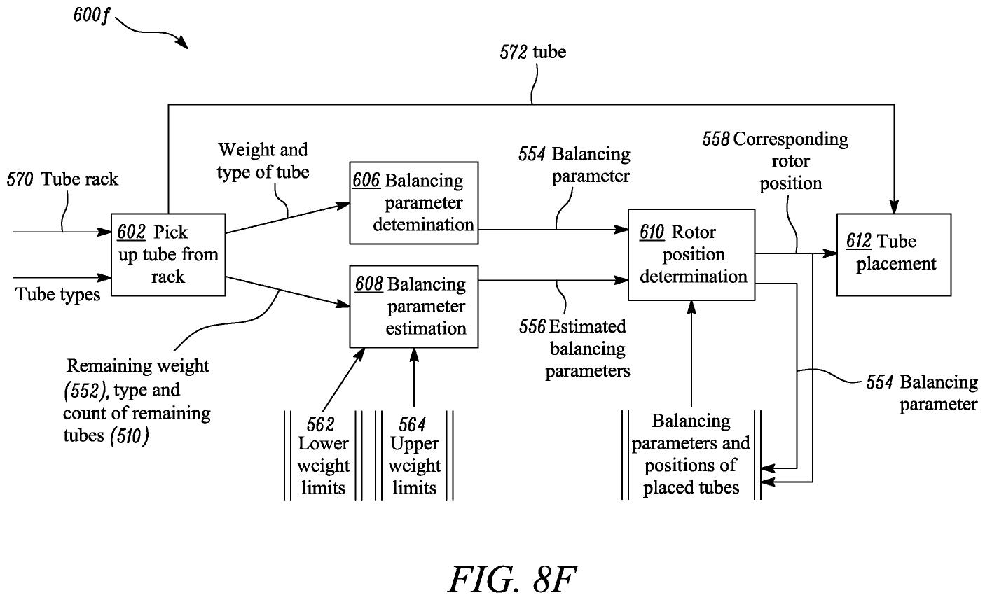

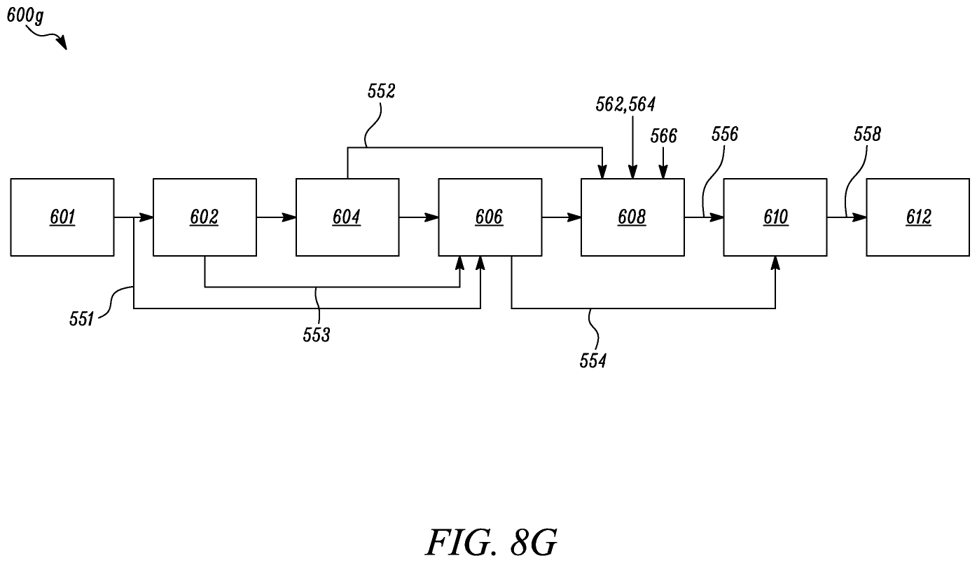

A lower weight limit 562 (shown in FIG. 8) and an upper weight limit 564 (shown in FIG. 8) of a tube 502 may be determined based on its tube type. For example, the lower weight limit 562 of the tube 502 may be a weight of the tube 502 when the tube 502 is empty and the upper weight limit 564 of the tube 502 may be a weight of the tube 502 when the tube 502 is fully filled. The lower weight limit 562 and the upper weight limit 564 of the tube 502 may be determined based on the tube type of the tube 502. Further, a geometry 566 (shown in FIG. 8) of the tube 502 may be determined based on the tube type of the tube 502.

As discussed above, one or more of the tubes 502 may comprise the one or more identifiers 504. The one or more identifiers 504 may comprise information related to the biological sample contained in the tubes 502. The information may comprise one or more analyses in which the biological sample is to be used, the type of biological sample, a date of collection of the biological sample, patient information, tube information (e.g., the tube type, the volume, etc.), and the like. In some embodiments, the one or more identifiers 504 may comprise a bar code, which may comprise encoded information and is optically read, as well as a Radio Frequency Identification (RFID) tag that may transmit the information via radio waves.

FIG. 8A illustrates a schematic block diagram of a method 600 for balancing the centrifuge 400 having the rotor 450 (shown in FIG. 3), according to an embodiment of the present disclosure. The method 600 will further be described with reference to FIGS. 1 and 9A to 12.

Before proceeding with the method 600, a total weight of a plurality of tubes to be placed in the centrifuge 400 is known or estimated. For example, the total weight of the plurality of tubes 572 in the tube rack 570 is known or estimated. The total weight of the plurality of tubes 572 in the tube rack 570 may be determined and/or estimated by various methods, such as, based on a difference between a pre-tube removal weight 551 of the tube rack 570 and a known empty weight 505 of the tube rack 570, via a user input by the operator, via the sensor 330 (shown in FIGS. 5A-5C), and so forth.

Further, the tube type of each of the plurality of tubes to be placed in the centrifuge 400 is known. For example, the tube type of each of the plurality of tubes 572 in the tube rack 570 is known. Since the tube type of each of the plurality of tubes to be placed in the centrifuge 400 is known, the lower and upper weight limits 562, 564 of each of the plurality of tubes to be placed in the centrifuge 400 is also known. Further, since the tube type of each of the plurality of tubes to be placed in the centrifuge 400 is known, the geometry 566 of each of the plurality of tubes to be placed in the centrifuge 400 is also known.

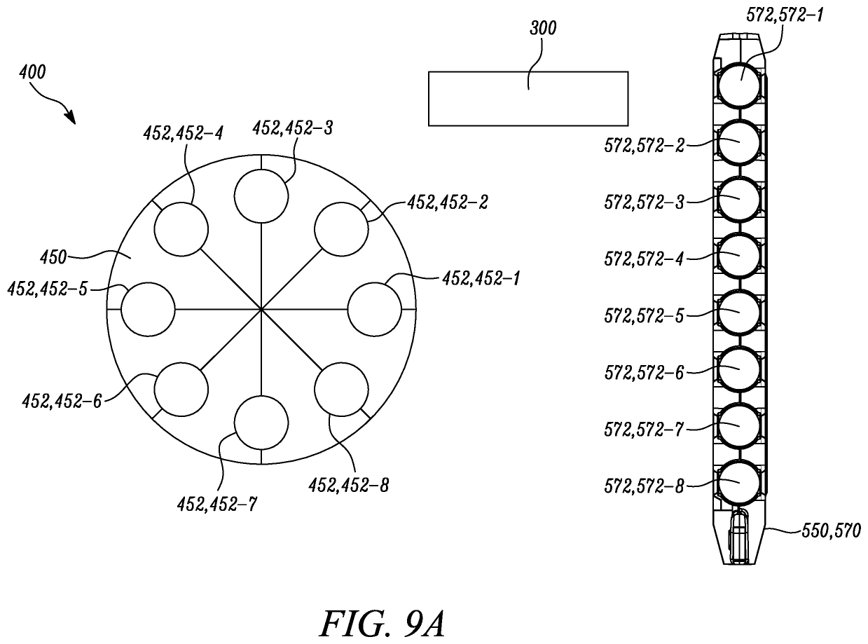

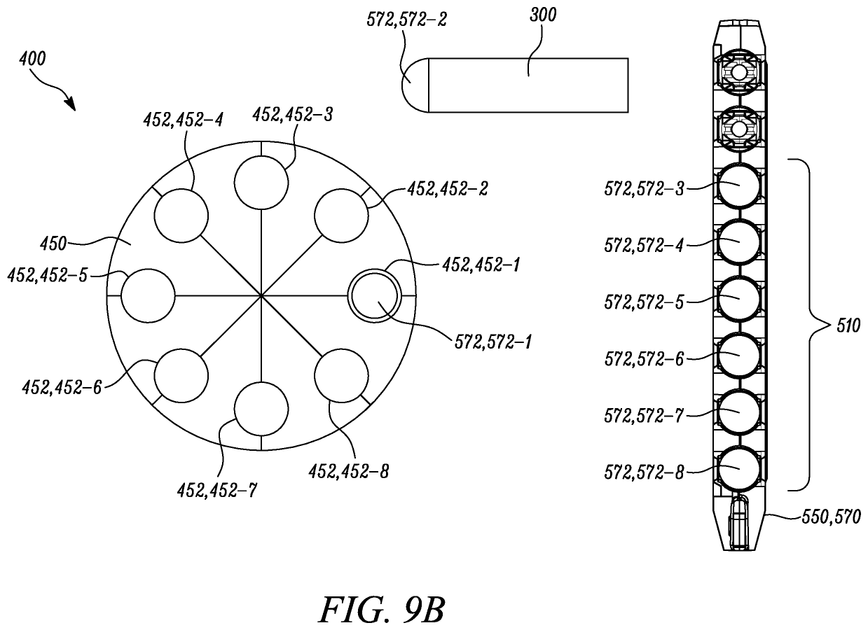

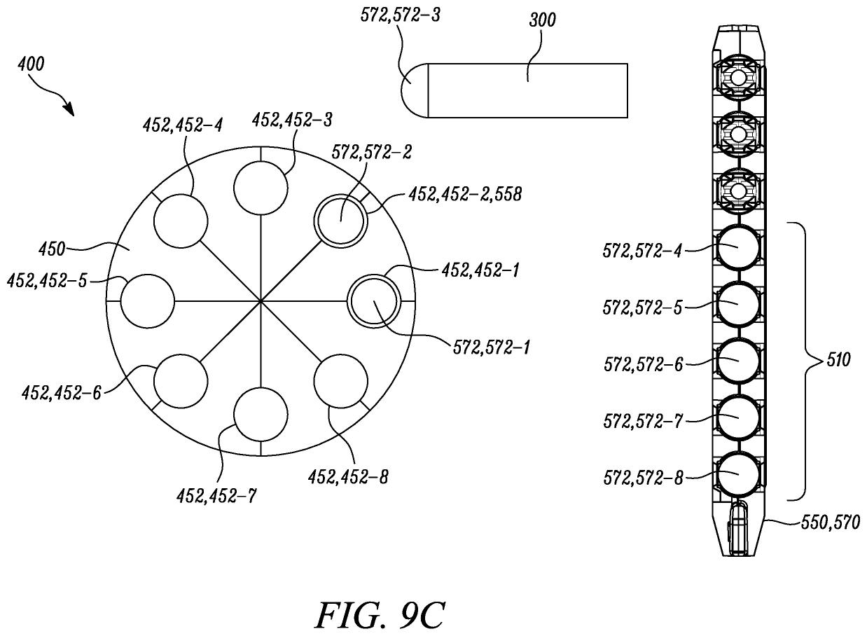

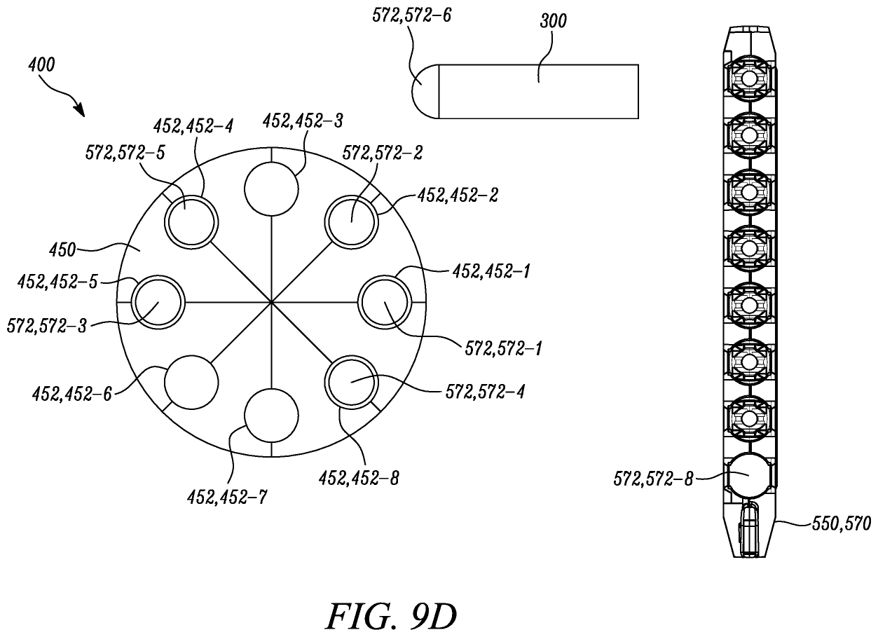

Referring to FIG. 9A, the rotor 450 comprises eight rotor positions 452-1 to 452-8. Further, the tube rack 570 comprises the plurality of tubes 572. In the illustrated embodiment of FIG. 9A, the plurality of tubes 572 comprises seven tubes 572-1 to 572-7. In the illustrated embodiment of FIG. 9B, the plurality of tubes 572 comprises eight tubes 572-1 to 572-8.

With reference to FIG. 9B, in some embodiments, the transport unit 300 may remove the tube 572-1 from the plurality of tubes 572 from the tube rack 570 and place the tube 572-1 in any one of the plurality of rotor positions 452 within the rotor 450. In the illustrated embodiment of FIG. 9B, the transport unit 300 places the tube 572-1 in the rotor position 452-1.

At step 602, the method 600 comprises removing, by the transport unit 300, a tube 572 from the plurality of tubes 572 from the tube rack 570 configured to removably hold the plurality of tubes 572. In the illustrated embodiment of FIG. 9B, the transport unit 300 removes the tube 572-2 from the plurality of tubes 572 from the tube rack 570.

Furthermore, at step 602, the method 600 may determine a weight of the tube 572 which was removed from the tube rack 570. This may be determined in various ways. The weight of the tube 572 may be estimated and/or directly measured. For example, the weight of the tube 572 may be calculated as the pre-tube removal weight 551 of the tube rack 570 before removing the tube 572, minus the post-tube removal weight 553 of the tube rack 570 after removing the tube 572. For another example, the tube weight may be determined by weighing the tube 572 by the at least one sensor 330 in the pick-and-place device 310 (shown in FIGS. 5A-5C).

Furthermore, at step 602, the method 600 may determine a remaining weight 552 of a plurality of remaining tubes 510 from the plurality of tubes 572 in the tube rack 570 after the tube 572 has been removed from the tube rack 570. For example, the remaining weight 552 may be calculated as the post-tube removal weight 553 of the tube rack 570 after the tube 572 has been removed, minus the empty weight 505 of the tube rack 570. For another example, the remaining weight 552 may be calculated as the remaining weight 552 prior to removing the tube 572, minus the weight of the tube 572.

Furthermore, in examples in which the type of each of the tubes 572 in the tube rack 570 is known, the type of the tube 572 which was removed from the tube rack 570 is known. The count and the type of the remaining tubes 510 may also be known.

At step 606, the method 600 comprises determining, by the computing device 200, a balancing parameter 554 of the tube 572. For example, the method 600 may comprise determining the balancing parameter 554 of the tube 572-2.

In some embodiments, the balancing parameter 554 of the tube 572 and/or the weight of the tube is determined, at least in part, by the transport unit 300. Specifically, the at least one sensor 330 (shown in FIGS. 5A-5C) is configured to determine, at least in part, the balancing parameter 554 of the tube 572.

In some embodiments, the balancing parameter 554 comprises a weight of the tube 572. In some embodiments, the balancing parameter 554 comprises a moment with respect to the centrifuge axis A1 (shown in FIG. 3) of the tube 572 when placed within the rotor 450. The moment of the tube 572 may be determined based on the weight of the tube 572 and the geometry 566 of the tube 572. Further, as discussed above, since the tube type of each of the plurality of tubes to be placed in the centrifuge 400 is known, the geometry 566 of each of the plurality of tubes to be placed in the centrifuge 400 is also known.

At step 608, the method 600 comprises determining, by the computing device 200, an estimated balancing parameter 556 of each of the plurality of remaining tubes 510 based at least on the remaining weight 552 of the plurality of remaining tubes 510 in the tube rack 570. For example, the method 600 may comprise determining the estimated balancing parameter 556 of each of the five remaining tubes 510 based at least on the remaining weight 552 of the five remaining tubes 510 in the tube rack 570. Since the balancing parameter 554 of each of the plurality of remaining tubes 510 is not known at this step, the method 600 may not require pre-weighing each of the plurality of tubes 572 individually to determine, at least in part, the balancing parameter 554 of each of the plurality of tubes 572. Therefore, the method 600 may be quicker than conventional methods which require pre-weighing each of a plurality of tubes, to be placed in a centrifuge, individually to determine the weight of each of the plurality of tubes.

Referencing FIG. 8B, in some embodiments, the pre-tube removal, post-tube removal and empty rack weights are not used, the remaining weight 552 is unknown, and therefore is not utilized by step 608.

In some embodiments, the step of determining the estimated balancing parameter 556 of each of the plurality of remaining tubes 510 further comprises determining an average weight of the plurality of remaining tubes 510 is based on a count of the plurality of remaining tubes 510 and the remaining weight 552 of the plurality of remaining tubes 510 in the tube rack 570. The estimated balancing parameter 556 of each of the plurality of remaining tubes 510 comprises the average weight of the plurality of remaining tubes 510. For example, the step of determining the estimated balancing parameter 556 of each of the six remaining tubes 510 in the tube rack 570 further comprises determining an average weight of the six remaining tubes 510 (i.e., the remaining weight 552 divided by 6). The estimated balancing parameter 556 of each of the six remaining tubes 510 in the tube rack 570 comprises the average weight of the six remaining tubes 510.

According to some examples, the step of determining the estimated balancing parameter 556 of each of the plurality of remaining tubes is based on at least a record of tube weights of the tubes 552 of corresponding tube types which were previously picked up by a transport unit 300. This may allow for more accurate estimated balancing parameters 556 according to a particular laboratory's usage of the tubes 552 of each type. For example, as each of the weights and types of the tubes 552 are determined, the weight of the tube is stored in a table according to its tube type. The table may include the tube weights from previous centrifuge runs. Then the estimated balancing parameter 556 may be based on the stored weights of the corresponding tube type. For example, the weights for the tubes of type A may be stored in a table A, and the weights for the tubes of type B may be stored in a table B. Subsequently, when the estimated balancing parameter 556 is determined for one of the tubes of type A, the estimated balancing parameter 556 may be based at least on the entries in the Table A, and when the estimated balancing parameter 556 is determined for one of the tubes of type B, the estimated balancing parameter 556 may be based at least on the entries in the Table B. This example shows that it may be possible for the method to be trained to the practices used by a particular centrifuge or a laboratory.

In some embodiments, the step of determining the estimated balancing parameter 556 of each of the plurality of remaining tubes 510 is based on a statistical model. In some embodiments, the statistical model may comprise a Bayesian model. In some embodiments, the statistical model may be any suitable statistical model, as per desired application attributes.

In some embodiments, the method 600 further comprises, receiving, by the computing device 200, the lower weight limit 562 and the upper weight limit 564 of each of the plurality of tubes 572. In some embodiments, the step of determining the estimated balancing parameter 556 of each of the plurality of remaining tubes 510 is further based on the lower weight limit 562 and the upper weight limit 564 of each of the plurality of tubes 572.

In some embodiments, the step of determining the estimated balancing parameter 556 of each of the plurality of remaining tubes 510 further comprises determining a probability distribution of the balancing parameter 554 of each of the plurality of remaining tubes 510 based at least on the remaining weight 552 of the plurality of remaining tubes 510 in the tube rack 570, the lower weight limit 562 of the corresponding remaining tube, and the upper weight limit 564 of the corresponding remaining tube. For example, referring to FIG. 9B, the estimated balancing parameter 556 of the tube 572-3 of the six remaining tubes 510 in the tube rack 570 comprises determining the probability distribution of the balancing parameter 554 of the tube 572-3 based at least on the remaining weight 552 of the six remaining tubes 510 in the tube rack 570, the lower weight limit 562 of the tube 572-3, and the upper weight limit 564 of the tube 572-3. Similarly, the probability distribution of each of the tubes 572-4, 572-5, 572-6, 572-7, and 572-8 is determined to determine the estimated balancing parameter 556 of the corresponding tube 572-4, 572-5, 572-6, 572-7, and 572-8.

In various embodiments, the estimated balancing parameter 556 of the remaining tubes 510 in the tube rack 570 is based on a mean of the upper weight limit 564 and the lower weight limit 562.

In some embodiments, the step of determining the estimated balancing parameter 556 of each of the plurality of remaining tubes 510 is based on a predetermined typical weight of the corresponding tube type.

In some embodiments, the step of determining the estimated balancing parameter 556 of each of the plurality of remaining tubes 510 further comprises determining a combined probability distribution based on the probability distribution of the balancing parameter 554 of each of the plurality of remaining tubes 510.

In some embodiments, the tube rack 570 may comprise a plurality of weight sensors disposed spaced apart from each other. For example, the tube rack 570 may comprise two weight sensors placed opposite to each other. A weight of the tube rack 570 determined by the plurality of weight sensors disposed spaced apart from each other may further help to determine or validate the combined probability distribution of the plurality of remaining tubes 510 in the tube rack 570.

In some embodiments, the step of determining the estimated balancing parameter 556 of each of the plurality of remaining tubes 510 further comprises determining a set of fractiles of the combined probability distribution. In some examples, the set of fractiles may be determined using appropriate probability fractions obtained by the equation:

$${f}_{i} = \frac{0.5 + i}{n} ( i = 0 , 1 , 2 , … , n - 1 )$$

where n is the total number of the plurality of remaining tubes 510.

In some cases, the set of fractiles may be determined using any other method, as per desired application attributes.

In some embodiments, the step of determining the estimated balancing parameter 556 of each of the plurality of remaining tubes 510 further comprises determining a set of estimated balancing parameters of each of the plurality of remaining tubes 510 based on the set of fractiles and the combined probability distribution. The set of estimated balancing parameters comprises the estimated balancing parameter 556 of each of the plurality of remaining tubes 510. For example, a first estimated balancing parameter in the set of estimated balancing parameters may have a value of the balancing parameter corresponding to a first fractile of the set of fractiles in the combined probability distribution. Further, the first estimated balancing parameter in the set of estimated balancing parameters may correspond to the estimated balancing parameter of one of the plurality of remaining tubes 510.

In some embodiments, the estimated balancing parameter of each of the plurality of remaining tubes 510 comprises an estimated weight of the corresponding remaining tube. Therefore, the combined probability distribution of the balancing parameter 554 of each of the plurality of remaining tubes 510 corresponds to a combined probability distribution of the weights of the remaining tubes 510.

In some embodiments, the estimated balancing parameter of each of the plurality of remaining tubes 510 comprises an estimated moment with respect to the centrifuge axis A1 (shown in FIG. 3) of the corresponding remaining tube when placed within the rotor 450. Therefore, the combined probability distribution of the balancing parameter 554 of each of the plurality of remaining tubes 510 corresponds to a combined probability distribution of the moments of the remaining tubes 510 when placed within the rotor 450.

In some embodiments, the step of determining the estimated balancing parameter 556 of each of the plurality of remaining tubes 510 further comprises receiving, by the computing device 200, the geometry 566 of each of the plurality of tubes 572. In some embodiments, the probability distribution of the balancing parameter 554 of each of the plurality of remaining tubes 510 is determined further based on the geometry 566 of the corresponding remaining tube. For example, referencing FIG. 9B, the estimated balancing parameter 556 of the tube 572-3 of the six remaining tubes 510 comprises determining the probability distribution of the balancing parameter 554 of the tube 572-3 further based further on the geometry 566 of the tube 572-3. The geometry 566 of each of the plurality of tubes 572 may help in estimating a distance between a center of mass/gravity of the corresponding tube 572 and the centrifuge axis A1 (shown in FIG. 3). The distance between the center of mass/gravity of the corresponding tube 572 and the centrifuge axis A1 is required to determine the moment with respect to the centrifuge axis A1.

Depending on the embodiment, determining the estimated balancing parameters 556 may be based on some or all of the remaining weight 552, type and count of the remaining tubes 510, the record of tube weights, predetermined typical tube weights, the lower weight limits 562, the upper weight limits 564, and/or the tube geometries 566. For example, referencing the method 600b FIG. 8B, the estimated balancing parameters 556 may be based on the type and count of the remaining tubes 510, the lower weight limits 562, the upper weight limits 564, and the tube geometries 566. For another example, referencing the method 600c of FIG. 8C, the estimated balancing parameters 556 may be based on the type and count of the remaining tubes 510, the remaining weight 552, the record of tube weights, and the tube geometries 566. For another example, referencing the method 600d FIG. 8D, the estimated balancing parameters 556 may be based on the type and count of the remaining tubes 510, the record of tube weights, the lower and weight limits 562, the upper weight limits 564, and the tube geometries 566. For another example, referencing the method 600e of FIG. 8E, the estimated balancing parameters 556 may be based on the type and count of the remaining tubes 510, the remaining weight 552, and the tube geometries 566. For another example, referencing the method 600f of FIG. 8F, the estimated balancing parameters 556 may be based on the type and count of the remaining tubes 510, the remaining weight 552, the record of tube weights, and the tube geometries 566. The estimated balancing parameters 556 may be based on other combinations of some or all of the remaining weight 552, type and count of the remaining tubes 510, the record of tube weights, the typical tube weights, the lower weight limits 562, the upper weight limits 564, and/or the tube geometries 566.

At step 610, the method 600 comprises determining, by the computing device 200, a corresponding rotor position 558 from the plurality of rotor positions 452 within the rotor 450 for the tube 572 based at least on the balancing parameter 554 of the tube 572, the balancing parameters 554 of previously placed tubes 572 from the plurality of tubes 572 placed within the rotor 450, and the estimated balancing parameter 556 of each of the plurality of remaining tubes 510. For example, referencing FIG. 9B, the method 600 may comprise determining, the corresponding rotor position 558 from the plurality of rotor positions 452 within the rotor 450 for the tube 572-2 based at least on the balancing parameter 554 of the tube 572-2, the balancing parameter 554 of the tube 572-1, and the estimated balancing parameter 556 of each of the six remaining tubes 510. Therefore, the computing device 200 may determine a best position to place the tube 572-2 which would yield a minimum imbalance by considering the balancing parameter 554 of the tube 572-2, the balancing parameter 554 of the tube 572-1, and the estimated balancing parameter 556 of each of the six remaining tubes 510 as its balancing parameter.

In some embodiments, the step of determining the corresponding rotor position 558 within the rotor 450 for the tube 572 further comprises minimizing a magnitude of an imbalance vector produced by a possible placement of the plurality of tubes 572 within the rotor 450. For example, the step of determining the corresponding rotor position 558 within the rotor 450 for the tube 572-2 comprises minimizing the magnitude of the imbalance vector produced by the possible placement of the tubes 572-1 to 572-8 within the rotor 450 based on the balancing parameter 554 of the tube 572-1, the balancing parameter 554 of the tube 572-2, and the estimated balancing parameter 556 of each of the tubes 572-3 to 572-8.

In some embodiments, minimizing the magnitude of the imbalance vector further comprises creating a plurality of permutations corresponding to a plurality of possible placements of the plurality of tubes 572 within the rotor 450. In some embodiments, each permutation comprises a corresponding set of rotor positions for the plurality of tubes 572. In some embodiments, minimizing the magnitude of the imbalance vector further comprises determining an imbalance vector for each of the plurality of permutations based at least on the balancing parameter 554 of the tube 572, the balancing parameters 554 of the previously placed tubes 572 from the plurality of tubes 572 placed within the rotor 450, the estimated balancing parameter 556 of each of the plurality of remaining tubes 510, and the corresponding set of rotor positions for the plurality of tubes 572. In some embodiments, minimizing the magnitude of the imbalance vector further comprises selecting the imbalance vector with a minimum magnitude. The corresponding set of rotor positions of the permutation corresponding to the imbalance vector with the minimum magnitude comprises the corresponding rotor position 558 within the rotor 450 for the tube 572.

For example, a first permutation may comprise possible placement of the tubes 572-2 to 572-8 in the rotor positions 452-2 to 452-8, respectively (i.e., the tube 572-2 in the rotor position 452-2, the tube 572-3 in the rotor position 452-3, and so forth). A second permutation may comprise possible placement of the tubes 572-2 to 572-8 in the rotor positions 452-8 to 452-2, respectively (i.e., the tube 572-2 in the rotor position 452-8, the tube 572-3 in the rotor position 452-7, and so forth). The imbalance vector may be computed for each of the first and second permutations. Similarly, imbalance vectors may be computed for other possible permutations. The imbalance vector with the minimum magnitude may then be selected. The rotor position of the tube 572-2 is provided by the permutation resulting in the imbalance vector with the minimum magnitude. For example, if the first permutation results in the imbalance vector with the minimum magnitude, the rotor position 452-2 is the corresponding rotor position of the tube 572-2.

According to various examples, a group of the plurality of permutations for each corresponding rotor position 558 is created such that all of the plurality of permutations in each of the groups share the same corresponding rotor position 558. The estimated magnitude of the imbalance vector for each group may be determined based on the imbalance vectors of the permutations contained in the group. In some embodiments, determining the corresponding rotor position 558 within the rotor 450 for the tube 572 is based on a consensus of a plurality of permutations. In some examples, the plurality of permutations comprises different sets of permutations, such that each set of permutations corresponds to a specific empty rotor position. In some examples, the consensus may be based on weighted averages of the magnitudes of the imbalance vectors of the different sets of permutations. For example, each weight may be the inverse of the magnitude of the imbalance vector. For example, the inverse of each of the permutations having a particular corresponding rotor position is calculated. These inverses are the weights. The weighted mean is a numerator, divided by a denominator. The numerator is the sum of each imbalance magnitude multiplied by its corresponding weight. The denominator is the sum of the weights.

In some examples, the magnitude of the imbalance vector for each group is based on at least a weighted vote. The weighted vote may be based on at least the rank of the magnitude of the imbalance vectors. For example, first, the rank of the imbalance magnitude is determined for each of all of the permutations (all corresponding rotor positions included). A weight is assigned to each permutation according to its rank. For example the rank 1 permutation may be given a weight of 10, rank 2 has a weight of 9, etc., through rank 9 given a weight of 1, and rank 10 and all higher ranks are given weights of 0. Then, for each corresponding rotor position, the weights for the permutations having that corresponding rotor position are added. The corresponding rotor position is finally selected as the one having the largest sum of weights.

Referring to FIG. 9C, the determined corresponding rotor position 558 is the rotor position 452-2. At step 612, the method 600 comprises placing, by the transport unit 300, the tube 572 in the corresponding rotor position 558 within the rotor 450. For example, the method 600 may comprise placing the tube 572-2 in the rotor position 452-2 within the rotor 450. In some embodiments, the system 100 (shown in FIG. 2A) is configured rotate the rotor 450, such that the access opening 412 (shown in FIG. 3) is at least aligned with the corresponding rotor position 558 within the rotor 450. In some embodiments, the transport unit 300 is configured to access the rotor 450 by moving vertically through the access opening 412 to place the tube 572 in the corresponding rotor position 558 within the rotor 450.

In some embodiments, the method 600 comprises repeating the steps 602 to 612. For example, the method 600 comprises repeating the steps 602 to 612 for placing the tube 572-3 in the corresponding rotor position 558 within the rotor 450.

In some embodiments, the method 600 is simplified when the count of remaining tubes 510 after removing the tube 572 from the tube rack 570 is one. If the count of remaining tubes 510 is one, the weight of the one remaining tube 510 is known, because it equals the remaining weight 552. Step 608 can be simplified because the estimated balancing parameter 556 of the one remaining tube 510 can be calculated, instead of estimated. For example, the estimated balancing parameter 556 may be the remaining weight 552 of the one remaining tube 51. For another example, the estimated balancing parameter may be calculated using the remaining weight 552 of the one remaining tube 510, and the tube geometry 566 corresponding to the tube type of the one remaining tube 510.

In some embodiments, the method 600 is simplified when the count of remaining tubes 510 after removing the tube 572 from the tube rack 570 is zero. If the count of remaining tubes 510 is zero, step 608 may be omitted, and the estimated balancing parameters 556 are not used by step 610 to determine the corresponding rotor position 558.

Referring to FIG. 9D, in some embodiments, the method 600 comprises repeating the steps 602 to 612 until two tubes 572, to be placed in the empty rotor positions 452e from the plurality of rotor positions 452, are remaining in the tube rack 570. For example, the method 600 comprises repeating the steps 602 to 612 until the two last tubes 572-7, 572-8 are remaining in the tube rack 570. Therefore, the steps 602 to 612 are repeated until the tube 572-6 is removed from the tube rack 570 and placed in the corresponding rotor position 558 within the rotor 450. In the illustrated example of FIG. 9D, the tubes 572-3, 572-4, 572-5, 572-6 have already been placed in the rotor positions 452-5, 452-8, 452-4, 452-3, respectively.

Referring to FIGS. 9A-9D, the number of the rotor positions 452 is eight and the number of the plurality of tubes 572 in the tube rack 570 are eight. Therefore, when the tube 572-6 is removed from the tube rack 570, and the tube 572-7 is remaining in the tube rack 570, there may be two of the empty rotor positions 452e (shown in FIG. 3) left within the rotor 450. In the illustrated example of FIG. 9D, the rotor positions 452-6, 452-7 are empty.

The steps 602 to 612 are not repeated for the tube 572-7 and the tube 572-8. This is because, when the tube 572-7 is removed from the tube rack 570, its balancing parameter is determined. Further, since there is only one remaining tube, i.e., the tube 572-8 in the tube rack 570, there is no need to estimate balancing parameters of the tube 572-8. The computing device 200 may determine a corresponding rotor position, from the two of the empty rotor positions 452e, for the tubes 572-7, 572-8 based on the balancing parameters 554 of the tubes 572-7, 572-8. In some embodiments, the transport unit 300 may place the two tubes 572 in the rotor positions, such that the magnitude of the imbalance vector is minimized.

In some embodiments, the number of the rotor positions 452 may be equal to the number of the plurality of tubes 572 in the tube rack 570. For example, the number of the rotor positions 452 and the number of the plurality of tubes 572 in the tube rack 570 may be both eight. Therefore, when the two tubes, for example, seventh and eighth tubes are to be placed within the rotor 450, there may be only two of the empty rotor positions 452e left within the rotor 450. The computing device 200 may determine a corresponding rotor position for the seventh tube based on balancing parameters of the seventh and eighth tubes. In some embodiments, the transport unit 300 may place the seventh tube in the corresponding rotor position, such that the magnitude of the imbalance vector after placing the eighth tube is minimized. In some embodiments, the method 600 further comprises placing last tube, i.e., the eighth tube in a remaining rotor position from the plurality of rotor positions 452 within the rotor 450 after placing the seventh tube. Specifically, the method 600 comprises placing the last tube 572 in the only one empty rotor position 452e from the plurality of rotor positions 452 within the rotor 450.

Referring to FIG. 9D, in some embodiments, the method 600 comprises repeating the steps 602 to 612 until two tubes 572, to be placed in the empty rotor positions 452e from the plurality of rotor positions 452, are remaining in the tube rack 570. For example, the method 600 comprises repeating the steps 602 to 612 until the two last tubes 572-7, 572-8 are remaining in the tube rack 570. Therefore, the steps 602 to 612 are repeated until the tube 572-6 is removed from the tube rack 570 and placed in the corresponding rotor position 558 within the rotor 450. In the illustrated example of FIG. 9D, the tubes 572-1, 572-2, 572-3, 572-4, 572-5, 572-6 have already been placed in the rotor positions 452-1. 452-2, 452-5, 452-8, 452-4, 452-3, respectively.

FIG. 8G illustrates another schematic block diagram of a method 600g for balancing the centrifuge 400 having the rotor 450 (shown in FIG. 3), according to an embodiment of the present disclosure. The method 600g will further be described with reference to FIGS. 1 and 9A to 12.

At step 1002, the method 600g comprises removing, by the transport unit 300, a tube 572 from the plurality of tubes 572 from the tube rack 570 configured to removably hold the plurality of tubes 572. In the illustrated embodiment of FIG. 9B, the transport unit 300 removes the tube 572-2 from the plurality of tubes 572 from the tube rack 570.

At step 1004, the method 600g comprises receiving, at the computing device 200, a remaining weight 552 of a plurality of remaining tubes 510 from the plurality of tubes 572 in the tube rack 570 after the tube 572 has been removed from the tube rack 570. For example, the method 600g may comprise receiving the remaining weight 552 of five remaining tubes 510 in the tube rack 570.

At step 1006, the method 600g comprises determining, by the computing device 200, a balancing parameter 554 of the tube 572. For example, the method 600g may comprise determining the balancing parameter 554 of the tube 572-2.

In some embodiments, at step 1001, the method 600g further comprises receiving, at the computing device 200, the pre-tube removal weight 551 of the tube rack 570 before the tube 572 is removed from the tube rack 570 and receiving, at the computing device 200, a post-tube removal weight 553 of the tube rack 570 after the tube 572 is removed from the tube rack 570.

In some embodiments, the balancing parameter 554 of the tube 572 is determined, at least in part, by the transport unit 300. Specifically, the at least one sensor 330 (shown in FIGS. 5A-5C) is configured to determine, at least in part, the balancing parameter 554 of the tube 572.

At step 1008, the method 600g comprises determining, by the computing device 200, an estimated balancing parameter 556 of each of the plurality of remaining tubes 510 based at least on the remaining weight 552 of the plurality of remaining tubes 510 in the tube rack 570

At step 1010, the method 600g comprises determining, by the computing device 200, a corresponding rotor position 558 from the plurality of rotor positions 452 within the rotor 450 for the tube 572 based at least on the balancing parameter 554 of the tube 572, the balancing parameters 554 of previously placed tubes 572 from the plurality of tubes 572 placed within the rotor 450, and the estimated balancing parameter 556 of each of the plurality of remaining tubes 510.

At step 1012, the method 600g comprises placing, by the transport unit 300, the tube 572 in the corresponding rotor position 558 within the rotor 450.

In some embodiments, the method 600g comprises repeating the steps 1002 to 1012. For example, the method 600 comprises repeating the steps 1002 to 1012 for placing the tube 572-3 in the corresponding rotor position 558 within the rotor 450.

Referring back to FIGS. 9A-9D and FIG. 8A, in some embodiments, the plurality of tubes 572 comprises a plurality of tube types. In some embodiments, the plurality of tube types comprises a predominant tube type having a maximum number of tubes from the plurality of tubes 572. In some embodiments, the method 600 further comprises placing the tubes 572 of the predominant tube type in the empty rotor positions 452e after placing the tubes 572 not of the predominant tube type in the empty rotor positions 452e.

For example, the tubes 572-3 to 572-8 may have a tube type A. Since the tube type A comprises a maximum number of tubes from the plurality of tubes 572, the tube type A is the predominant tube type. Therefore, the method 600 may comprise placing the tubes 572-3 to 572-8 of the tube type A in the empty rotor positions 452e after placing the tubes 572-1 and 572-2 not of the tube type A in the empty rotor positions 452e.

In some embodiments, the method 600 further comprises identifying a plurality of groups of the plurality of tubes 572, such that the tubes 572 within each of the plurality of groups have a same tube type from the plurality of tube types. The plurality of tubes 572 are therefore grouped according to their respective tube types. In some embodiments, the method 600 further comprises placing the plurality of groups one after the other within the rotor 450.

For example, each tube 572 of a first group from the plurality of groups are placed in the empty rotor positions 452e prior to placing each tube 572 of a second group from the plurality of groups in the remaining of the empty rotor positions 452e, and so forth. Therefore, the tubes 572 belonging to one group may be first placed within the rotor 450 before the tubes 572 of another group.

In a further example, the tubes 572-3 to 572-8 may have a tube type A and may be grouped together as Group 1. Further, the tubes 572-1 and 572-2 may have a tube type B and may be grouped together as Group 2. The method 600 comprises identifying the Groups 1 and 2, such that the tubes within each of the Groups 1 and 2 have a same tube type from the tube types A and B. Further, the method 600 may comprise placing each tube of the Group 2 in the empty rotor positions 452e prior to placing each tube of the Group 1 in the remaining of the empty rotor positions 452e.

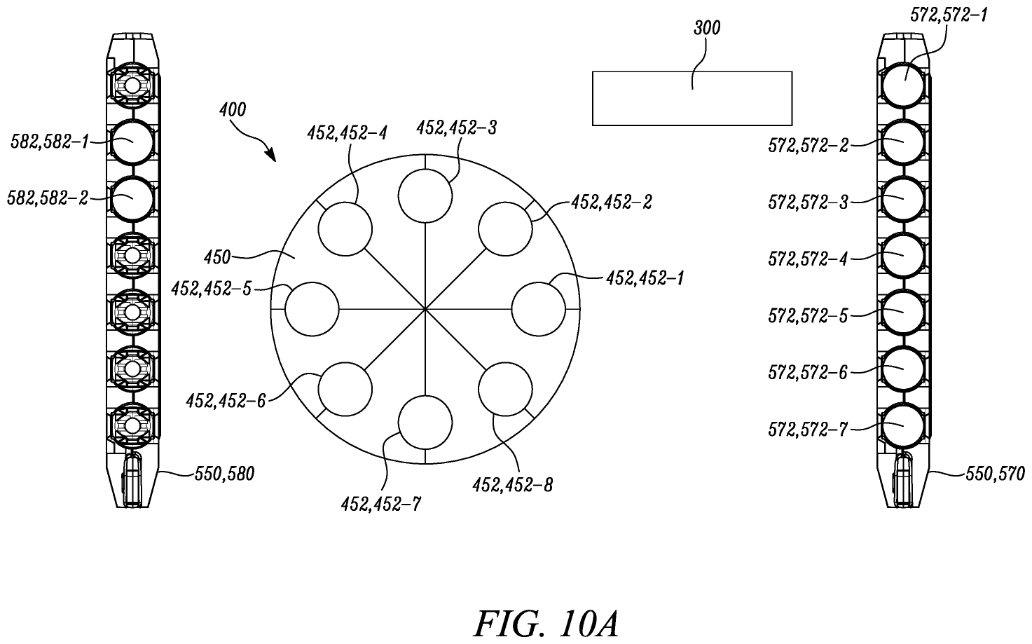

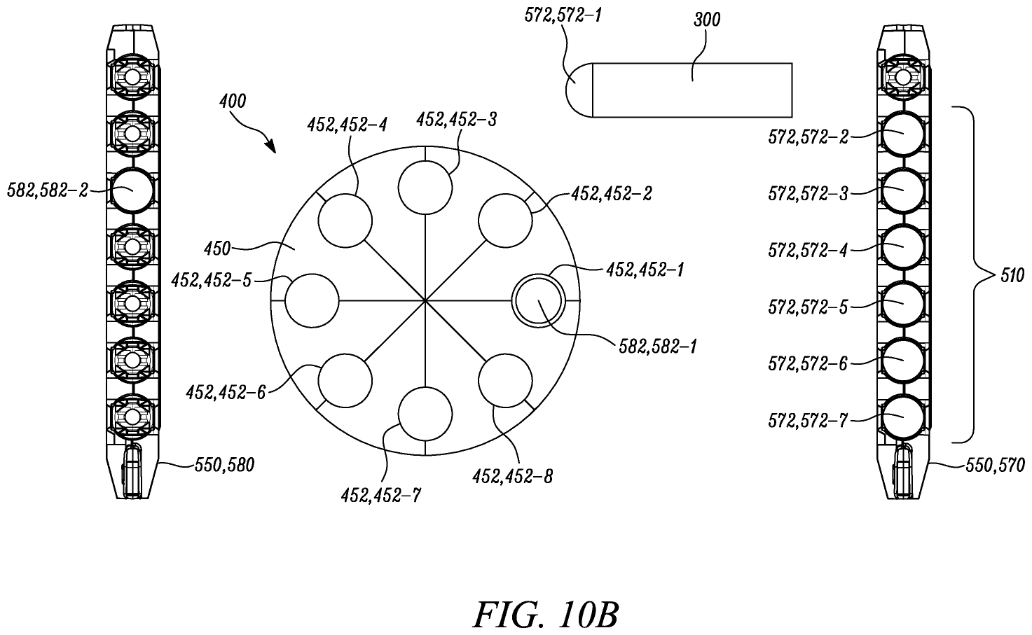

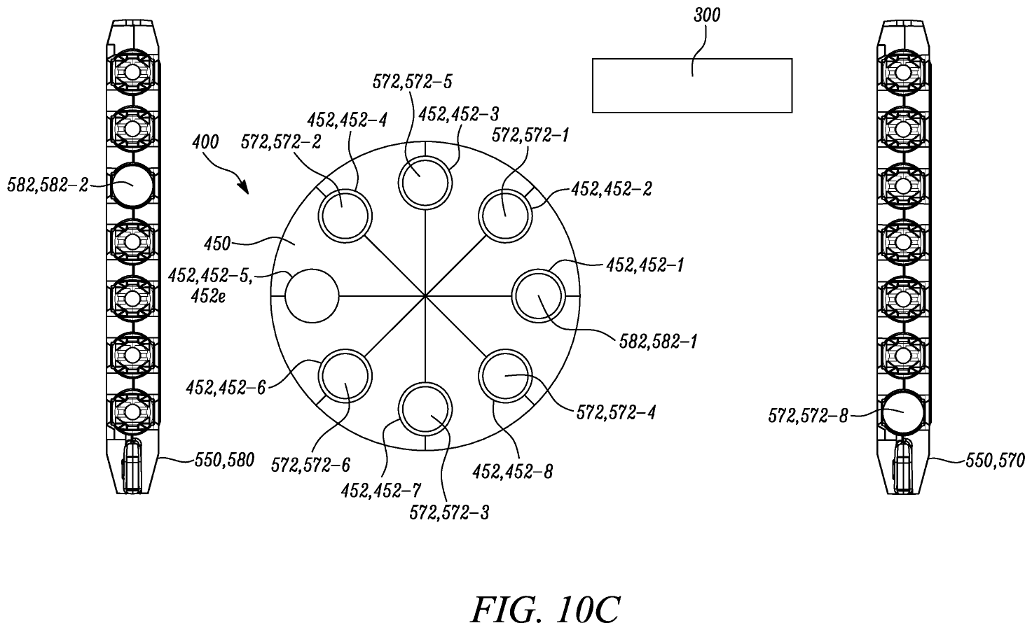

Referring to FIG. 10A, in some embodiments, the method 600 further comprises determining if count of the plurality of tubes 572 is less than count of the plurality of rotor positions 452.

In some embodiments, the method 600 further comprises selecting the one or more tubes 582 from the other tube rack 580 if the count of the plurality of tubes 572 is less than the count of the plurality of rotor positions 452. In such embodiments, the method 600 further comprises placing the one or more tubes 582 in one or more empty rotor positions 452e from the plurality of rotor positions 452 within the rotor 450.

In some embodiments, the method 600 further comprises determining if count of the one or more tubes 582 in the other tube rack 580 is less than the count of the plurality of tubes 572 in the tube rack 570.

For example, in the illustrated embodiment of FIG. 10A, the count of the one or more tubes 582 in the other tube rack 580 is two (i.e., a tube 582-1 and a tube 582-2) and the count of the plurality of tubes 572 in the tube rack 570 is seven (i.e., the tubes 572-1 to 572-7).

Referring to FIG. 10C, in some embodiments, the method 600 comprises placing one or more of the one or more tubes 582 from the other tube rack 580 within the rotor 450 prior to placing the plurality of tubes 572 from the tube rack 570 within the rotor 450 if the count of the one or more tubes 582 in the other tube rack 580 is less than the count of the plurality of tubes 572 in the tube rack 570.

Therefore, the transport unit 300 may place one of the two tubes 582 from the other tube rack 580 within the rotor 450 prior to placing seven tubes 572 from the tube rack 570 within the rotor 450.

As illustrated in FIG. 10C, the tube 582-1 is placed from the other tube rack 580 within the rotor 450 prior to placement of the seven tubes 572 from the tube rack 570 within the rotor 450.

In this example, the second to last tube to be placed may be the tube 572-6. When the tube 572-6 is picked up to be placed within the rotor 450, its balancing parameter 554 is determined. There is only one of the remaining tubes 510, so the weight of the one remaining tube 510 equals the remaining weight 552. The balancing parameter 554 of the one remaining tube can be calculated, rather than estimated. The balancing parameter of both the tube 572-6 and the tube 572-7 are known, so the corresponding rotor position 558 may be determined based on a balancing parameter 554 of the one remaining tube 510, rather than an estimated balancing parameter 556 of the one remaining tube 510. The tube 572-6 is then places in the corresponding rotor position 558. Finally, the tube 572-7 is picked up then placed in the one remaining empty rotor position.

Referring to FIG. 10C, in some embodiments, the method 600 may comprise placing one or more of the one or more tubes 582 from the other tube rack 580 within the rotor 450 prior to placing the plurality of tubes 572 from the tube rack 570 within the rotor 450 if the number of the one or more tubes 582 in the other tube rack 580 is less than the number of the plurality of tubes 572 in the tube rack 570, such that the number of the one or more tubes 582 is equal to the difference between the count of the rotor positions 542 and the count of the plurality of tubes 572 in the tube rack 570.

For example, the computing device 200 may determine that the count of the one or more tubes 572 in the other tube rack 570 is less than the count of the rotor positions 452. The computing device 200 may further determine that the difference between the count of the rotor positions 542 and the count of the plurality of tubes 572 in the tube rack 570 is one. Therefore, the method 600 may comprise placing one of the one or more tubes 582 from the other tube rack 580 within the rotor 450 prior to placing the plurality of tubes 572 from the tube rack 570 within the rotor 450.

For example, the transport unit 300 may place the tube 582-1 from the tube rack 580 prior to placing the tubes 572-1 to 572-7 from the tube rack 570 within the rotor 450.

This may ensure that each of the rotor positions 452 of the rotor 450 is occupied and the tube rack 570 is empty when each of the rotor positions 452 of the rotor 450 is occupied.

As illustrated in FIG. 10D, the tube 572-7 may then be placed in last remaining rotor position 452-5. In some embodiments, the tube 582-2 may be placed within the rotor 450 in a next cycle of the centrifuge process prior to placement of a plurality of tubes from a new rack (not shown).

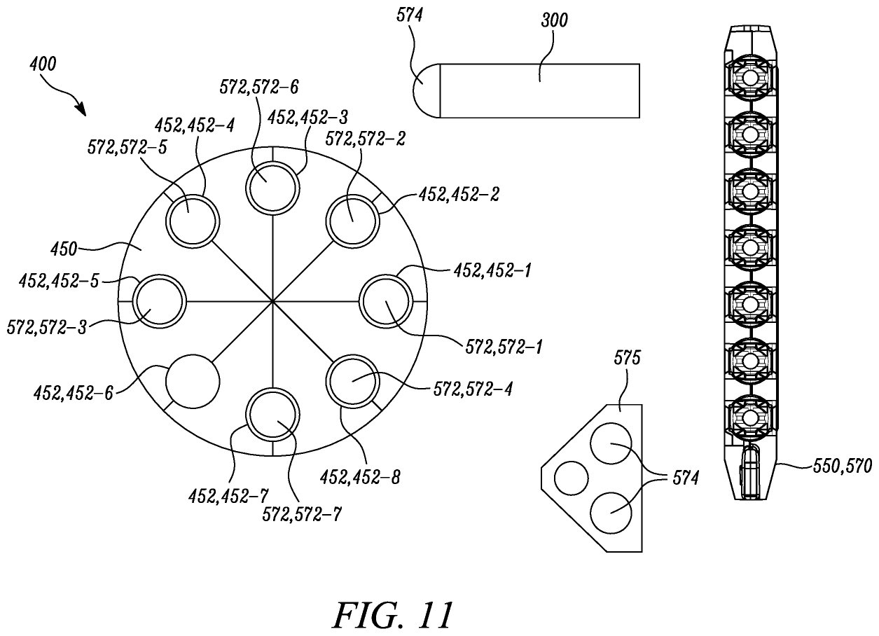

Referring to FIG. 11, in some embodiments, the method 600 may comprise selecting one or more of the dummy tubes 574 from the at least one dummy tube 574 and placing the one or more of the dummy tubes 574 in the empty rotor positions 452e from the plurality of rotor positions 452 within the rotor 450.

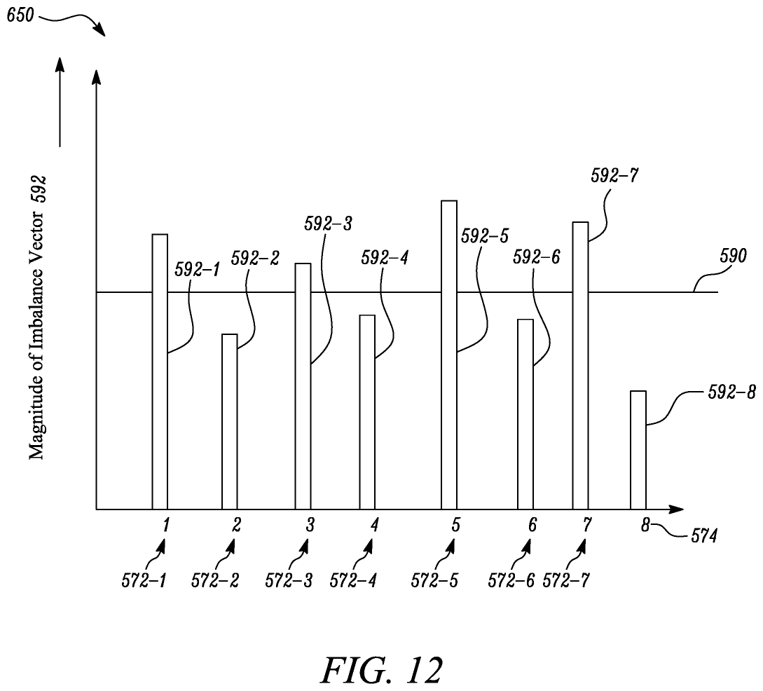

According to some examples, placing the one or more dummy tubes 574 may be based on an undesirable risk of a magnitude of an imbalance vector being greater than a predetermined threshold 590 after placing the last tube 572. In some embodiments, placing the one or more dummy tubes 574 results in a magnitude of an imbalance vector 592 being less than a predetermined threshold 590 (shown in FIG. 12). In some embodiments, the predetermined threshold 590 may be indicative of an imbalance acceptance limit. In some embodiments, the predetermined threshold 590 may be indicative of 50% of the imbalance acceptance limit. In some embodiments, the predetermined threshold 590 may be indicative of 25%, 30%, 40%, 60%, 70%, 75%, 80%, or 90% of the imbalance acceptance limit. The imbalance acceptance limit may vary for different types or sizes of the centrifuges 400.

In some embodiments, the count of the rotor positions 452 and the count of the plurality of tubes 572 in the tube rack 570 may be different. In some cases, this may be when count of the plurality of tube holding positions 555 (shown in FIGS. 6A, 6B, and 6C) of the tube rack 570 and the count of the rotor positions 452 is different, for example, count of the plurality of tube holding positions 555 in the tube rack 570 may be less than the count of the rotor positions 452. In some other cases, this may be when one or more of the plurality of tube holding positions 555 of the tube rack 570 are empty prior to the placement of any of the plurality of tubes 572 within the rotor 450.

For example, referring to FIG. 11, as discussed above, the count of the rotor positions 452 is eight and the count of the plurality of tubes 572 in the tube rack 570 is seven. Therefore, a difference between the count of the rotor positions 452 and the count of the plurality of tubes 572 in the tube rack 570 is one. Thus, when the last tube 572 is placed within the rotor 450, one of the rotor positions 452 may be left empty within the rotor 450.

In some embodiments, the method 600 may comprise determining if the count of the plurality of tubes 572 to be placed within the rotor 450 is less than the count of the rotor positions 452. In some embodiments, the one or more dummy tubes 574 are selected upon determining that the count of the plurality of tubes 572 to be placed within the rotor 450 is less than the count of the rotor positions 452.

According to various examples, the selection of the one or more dummy tubes 574 is done after all of the tubes 572 from the rack 580 have been placed. For example, the decision whether to place one or more dummy tubes 574 may be made before all of the tubes 572 from the rack 580 have been placed, but the actual selection of the one or more dummy tubes 574 is done after all the tubes 572 from the rack 580 have been placed.

In some embodiments, the one or more dummy tubes 574 are placed in the remaining of the empty rotor positions 452e after placing the plurality of tubes 572 within the rotor 450. In the illustrated example of FIG. 11, the dummy tube 574 is placed in the rotor position 452-6 that is left empty after placement of the plurality of tubes 572 within the rotor 450.

In some cases, the other tube rack 580 (shown in FIG. 10A) may not be present. In such cases, the one or more dummy tubes 574 may be placed in the remaining of the empty rotor positions 452e after placement of the plurality of tubes 572 from the tube rack 570 within the rotor 450.

In some cases, the other tube rack 580 may not have sufficient tubes 582 (shown in FIG. 10A). Therefore, there may still be remaining empty rotor positions 452e after placement of the plurality of tubes 572 from the tube rack 570 and the one or more tubes 582 from the other tube rack 580 within the rotor 450. In such cases, the one or more dummy tubes 574 may be placed in the remaining of the empty rotor positions 452e after placement of the plurality of tubes 572 from the tube rack 570 and the one or more tubes 582 from the other tube rack 580 within the rotor 450.

However, in some embodiments, the one or more dummy tubes 574 are placed in the rotor positions 452 within the rotor 450 after the balance parameters 554 of the plurality of tubes 572 are determined. For example, the one or more dummy tubes 574 are placed in the rotor positions 452 within the rotor 450 when two tubes 572 are remaining in the tube rack 570 or the one or more dummy tubes 574 are placed in the rotor positions 452 within the rotor 450 when one tube 572 is remaining in the tube rack 570.

In some embodiments, the one or more dummy tubes 574 are selected upon determining that an odd number of the tubes 572 are to be placed in the empty rotor positions 452e, and the rotor 450 comprises an even number of the rotor positions 452.

For example, a number of the tubes (e.g., the plurality of tubes 572) to be placed in the empty rotor positions 452e is an odd number seven and a number of the rotor positions 452 is an even number eight. In such cases, the one or more dummy tubes 574 are selected to be placed in the empty rotor positions 452e.

In some embodiments, the one or more dummy tubes 574 are selected upon determining that the plurality of tubes 572 comprises the plurality of tube types. A first tube type from the plurality of tube types comprises an odd number of the tubes 572 and the first tube type has a balance parameter that is substantially different from the balance parameters of remaining tube types from the plurality of tube types, such that an undesirable risk is determined of a magnitude of an imbalance vector 592 after placing the plurality of tubes 572 comprising the plurality of tube types being greater than the predetermined threshold 590 (shown in FIG. 12).

For example, the tube 572-4 may have a first tube type A and the tubes 572-3, 572-5, 572-6, and 572-7 may have a tube type B. The first tube type A from the plurality of tube types comprises an odd number (i.e., one) of the tubes 572. Further, the first tube type A may have a balance parameter that is substantially different from the balance parameters of remaining tube types from the plurality of tube types, such that the undesirable risk is determined of the magnitude of the imbalance vector 592 after placing the plurality of tubes 572 comprising the plurality of tube types is greater than the predetermined threshold 590. In such cases, one or more of the dummy tubes 574 may be selected and placed within the rotor 450, such that the centrifuge 400 is balanced. As discussed above, in some embodiments, the one or more of the dummy tubes 574 are placed after the balance parameters 554 (shown in FIG. 8) of the plurality of tubes 572 are determined.

In some embodiments, the plurality of tubes 572 comprises two tubes. In such embodiments, the method 600 further comprises placing two or more of the one or more dummy tubes 574 in the empty rotor positions 452e upon determining that the two tubes 572 are to be placed in the empty rotor positions 452e.

For example, the tube rack 570 may comprise only two tubes 572 to be placed in the empty rotor positions 452e and the tube types of the two tubes 572 may be different. Therefore, the rotor 450 may not be balanced even when the two tubes are placed opposite to each other (e.g., one of the two tubes having a greater balance parameter is placed within the rotor position 452-1 and other of the two tubes is placed within the rotor position 452-5). In such cases, the method 600 may comprise placing the two or more of the one or more dummy tubes 574 in the empty rotor positions 452e (e.g., one of the dummy tubes 574 is placed within the rotor position 452-2 and other of the dummy tubes 574 having a greater balance parameter is placed within the rotor position 452-6), such that the centrifuge 400 is balanced. In some cases, the method 600 may comprise placing four dummy tubes 574 in the empty rotor positions 452e (e.g., in the rotor positions 452-2, 452-6, 452-4, and 452-8), such that the centrifuge 400 is balanced.

FIG. 12 illustrates an exemplary plot 650 of a magnitude of an imbalance vector 592 after a probable placement of the plurality of tubes 572. The magnitude of the imbalance vector 592 is on the ordinate axis, and the plurality of tubes 572 is depicted on the abscissa.

Referring to the plot 650, a bar 592-1 is indicative of a probable magnitude of the imbalance vector 592 after placing the tube 572-1 within the rotor 450 (shown in FIG. 3), a bar 592-2 is indicative of a probable magnitude of the imbalance vector 592 after placing the tubes 572-1, 572-2 within the rotor 450, a bar 592-3 is indicative of a probable magnitude of the imbalance vector 592 after placing the tubes 572-1, 572-2, 572-3 within the rotor 450, a bar 592-4 is indicative of a probable magnitude of the imbalance vector 592 after placing the tubes 572-1 to 572-4 within the rotor 450, a bar 592-5 is indicative of a probable magnitude of the imbalance vector 592 after placing the tubes 572-1 to 572-5 within the rotor 450, a bar 592-6 is indicative of a magnitude of the imbalance vector 592 after placing the tubes 572-1 to 572-6 within the rotor 450, and a bar 592-7 is indicative of a magnitude of the imbalance vector 592 after placing the tubes 572-1 to 572-7 within the rotor 450.

Referring to FIGS. 11 and 12, in some embodiments, the one or more dummy tubes 574 are selected upon determining an undesirable risk of the magnitude of the imbalance vector 592 after placing the last tube 572 (i.e., the tube 572-7) being greater than the predetermined threshold 590. For example, there may be an undesirable risk that the magnitude (indicated by the bar 592-7) of the imbalance vector 592 after placing the tubes 572-1 to 572-7 is greater than predetermined threshold 590. In such embodiments, placing the one or more dummy tubes 574 results in the magnitude of the imbalance vector 592 being less than the predetermined threshold 590.

For example, one of the one or more dummy tubes 574 may be placed in the empty rotor position 452e. As is apparent from the plot 650, placing the one of the one or more dummy tubes 574 results in the magnitude of the imbalance vector 592 (depicted by a bar 592-8) being less than the predetermined threshold 590.

In some cases, the count of the plurality of tubes 572 may be equal to the count of rotor positions 452. In such cases, one or more of the at least one dummy tube 574 may replace one or more of the plurality of tubes 572 placed within the rotor 450 such that the replacement results in the magnitude of the imbalance vector 592 being less than the predetermined threshold 590.

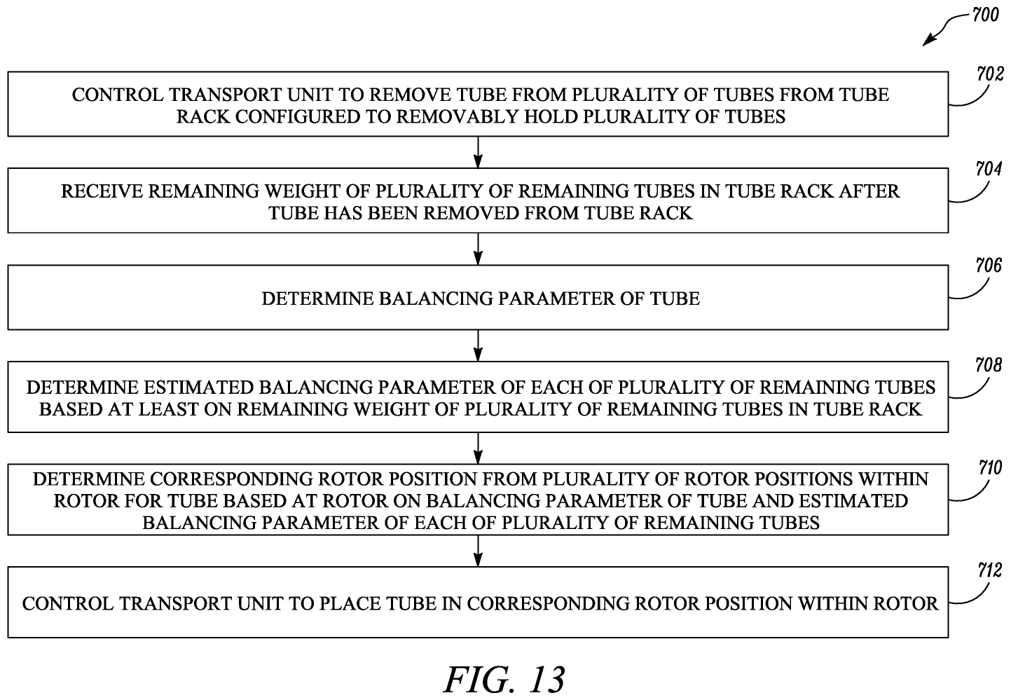

FIG. 13 is a flowchart illustrating a method 700 for balancing the centrifuge 400 (shown in FIG. 3), according to an embodiment of the present disclosure. The method 700 for balancing the centrifuge 400 may be substantially similar to the method 600 (shown in FIG. 8) for balancing the centrifuge 400. However, the method 700 may be a computer-implemented method. Referring to FIGS. 1 and 13, the at least one processor 220 is capable of executing the instructions 212 to perform the method 700. Therefore, the computing device 200 may implement the method 700. The method 700 will further be described with reference to FIGS. 1 and 9A to 12.

At step 702, the method 700 comprises controlling the transport unit 300 to remove the tube 572 from the plurality of tubes 572 from the tube rack 570 configured to removably hold the plurality of tubes 572.

At step 704, the method 700 further comprises receiving the remaining weight 552 of the plurality of remaining tubes 510 from the plurality of tubes 572 in the tube rack 570 after the tube 572 has been removed from the tube rack 570.

At step 706, the method 700 further comprises determining the balancing parameter 554 of the tube 572.

At step 708, the method 700 further comprises determining the estimated balancing parameter 556 of each of the plurality of remaining tubes 510 based at least on the remaining weight 552 of the plurality of remaining tubes 510 in the tube rack 570.

At step 710, the method 700 further comprises determining the corresponding rotor position 558 from the plurality of rotor positions 452 within the rotor 450 for the tube 572 based at least on the balancing parameter 554 of the tube 572, the balancing parameters 554 of the previously placed tubes 572 from the plurality of tubes 572 placed within the rotor 450, and the estimated balancing parameter 556 of each of the plurality of remaining tubes 510.

At step 712, the method 700 further comprises controlling the transport unit 300 to place the tube 572 in the corresponding rotor position 558 within the rotor 450.

Referring to FIGS. 1-13, the methods 600, 700 for balancing the centrifuge 400, the system 100 comprising the computing device 200 for performing the methods 600, 700, and the automated analyzer 500 comprising the system 100 of the present disclosure may provide an automated way of placing the tubes 502 within the rotor 450 of the centrifuge 400 while providing a good rotor balance without substantially adding cost and complexity to the centrifuge 400 and/or the automated analyzer 500.

Determining the estimated balancing parameter 556 of each of the plurality of remaining tubes 510 may obviate the need for individually weighing each tube 502 containing a quantity of the patient sample prior to loading within the rotor 450 and/or the tube rack 570.

Further, the methods 600, 700 for balancing the centrifuge 400 of the present disclosure may further reduce a number of breakdowns of the centrifuge 400, thereby preventing delays in a workflow of the automated analyzer 500, and may provide a quicker turnaround time and an increased throughput of the centrifuge 400 and/or the automated analyzer 500 than conventional methods. The methods 600, 700 for balancing the centrifuge 400 of the present disclosure may also minimize a downtime of the centrifuge 400 and may further prevent unavailability of one or more subassemblies of the automated analyzer 500.

The methods 600, 700 may further reduce human interventions, which may further increase the throughput of the centrifuge 400 and/or the automated analyzer 500. Further, the operator may leave the automated analyzer 500 unattended and may carry out other necessary tasks. This may also save a time of the operator.

The methods 600, 700 for balancing the centrifuge 400 of the present disclosure may further be used with a wide variety of existing equipment and/or existing automated analyzers, i.e., the existing equipment and/or the existing automated analyzers may not need to be replaced.

### EXAMPLES

The following illustrative examples are merely meant to exemplify the present invention, but they are not intended to limit or otherwise define the scope of the present disclosure. FIGS. 1 to 13 may also be referred to in this section for the purposes of explanation and/or illustration.

A centrifugal force exerted by a tube (e.g., the tube 502) is given by F=mrω² where F is the force, m is a mass of the tube, r is a distance from a center of rotation (e.g., the centrifuge axis A1) to a center of gravity of the tube, and @ is an angular velocity of a rotor (e.g., the rotor 450).

For a given rotor speed, w is the same for all the tubes, so the forces are proportional to mr, which is known as the tube's “moment”. The imbalance vector is a vector sum of all the moments. The magnitude of the imbalance vector is therefore calculated as the magnitude of the vector sum of all the moments.

### Example 1

In this example, it was assumed that all tubes (e.g., the tubes 502) to be placed within the rotor 450 were of a same tube type and there was a linear relationship between the moment and the weight of the tubes 502 to be placed within the rotor 450. In other words, r is constant. Therefore, in this example, the balance parameter was the weight of the tubes 502.

Further, in this example, an average weight of a plurality of remaining tubes (e.g., the plurality of remaining tubes 510) was determined based on count of the plurality of remaining tubes and a remaining weight. Therefore, an estimated balancing parameter (e.g., the estimated balancing parameter 556) of each of the plurality of remaining tubes comprised the average weight of the plurality of remaining tubes.

This example will further be described with reference to FIGS. 8, 10C, and 10D.

In this example, eight tubes were to be placed, and they weighed 4, 5, 4, 4, 3, 5, 5, and 6 grams. Since the tube rack 470 comprised only 7 of the tubes 572, the first tube (i.e., the tube 582-1) was selected from the other tube rack 580.

Initially, the tube 582-1 was placed, by the transport unit 300, in the rotor position 452-1. The weight of the tube 582-1 was 4 grams.

In a next step, only the total weight of 32 grams of the seven tubes from the tube rack 570 was received by and known to the computing device 200.

In a next step, the tube 572-1 was removed by the transport unit 300 from the tube rack 570.

In a next step, the weight of the tube 572-1 was determined. The weight of the tube 572-1 was 5 grams.

In a next step, the remaining weight 552 of the six remaining tubes 572-2 to 572-7 was received by the computing device 200. The remaining weight 552 of the six remaining tubes 572-2 to 572-7 was 27 grams.

In a next step, the average weight of the six remaining tubes 572-2 to 572-7 was determined by the computing device 200 based on the remaining weight 552. The average weight of the six remaining tubes was 4.5 grams. Therefore, the estimated weight of each of the six remaining tubes 572-2 to 572-7 was 4.5 grams.

In a next step, the computing device 200 determined a corresponding rotor position for the tube 572-1 based on the weight of the tube 572-1, the weight of the tube 582-1, and the average weight of the remaining tubes 572-2 to 572-7.

Specifically, the computing device 200 determined the magnitude of the imbalance vector produced by a possible placement of each of the tubes 572 to be placed within the rotor 450.

The computing device 200 determined the magnitude of the imbalance vector if the tube 572-1 was placed in the rotor position 452-2, the rotor position 452-3, the rotor position 452-4, or the rotor position 452-5. Since the rotor 450 is symmetric, the magnitude of the imbalance vector if the tube 572-1 was placed in the rotor position 452-6, the rotor position 452-7, or the rotor position 452-8 would be equal to the magnitude of the imbalance vector if the tube 572-1 was placed in the rotor position 452-4, the rotor position 452-3, or the rotor position 452-2, respectively.

Exemplary calculations to determine the magnitude of the imbalance vector are provided for reference below.

In order to determine the magnitude of the imbalance vector, an x-y axis such that the origin is at the centrifuge axis A1, the x axis is parallel to the vector from the centrifuge axis A1 to Position 1 (i.e., the rotor position 452-1), and the y axis is parallel to the vector from the centrifuge axis A1 to Position 3 (i.e., the rotor position 452-3) was defined. As discussed above, r was assumed to be constant. r was further assumed to be 1 unit.

Further, the vectors from the centrifuge axis A1 to the rotor positions 452 are given by (x,y)=(cos θ, sin θ), where θ=(Position−1)×45°.

Firstly, the magnitude of the imbalance vector if the tube 572-1 was placed in the rotor position 452-2 and the remaining tubes 510 were placed in other empty rotor positions of the rotor 450 was determined.

The value of x (i.e., the x component of the imbalance vector), if the tube 572-1 was placed in the rotor position 452-2 and the remaining tubes were placed in the other empty rotor positions, was sum of the contributions to x from the moments of the eight tubes. Each tube contributes its weight times cos θ:

$$x = 4 + \frac{5}{\sqrt{2}} + 4.5 ( 0 - \frac{1}{\sqrt{2}} - 1 - \frac{1}{\sqrt{2}} + 0 + \frac{1}{\sqrt{2}} ) = - 0.1464$$

The value of y (i.e., the y component of the imbalance vector), if the tube 572-1 was placed in the rotor position 452-2 and the remaining tubes were placed in the other empty rotor positions, was sum of the contributions to y from the moments of the eight tubes. Each tube contributes its weight times sin θ:

$$y = 0 + \frac{5}{\sqrt{2}} + 4.5 ( 1 + \frac{1}{\sqrt{2}} + 0 - \frac{1}{\sqrt{2}} - 1 - \frac{1}{\sqrt{2}} ) = 0.3536 .$$

In each of these sums, the first term was for the tube already within the rotor 450 (i.e., the tube 582-1), the second term is for the tube about to be placed (i.e., the tube 572-1), and the remaining terms are for the remaining tubes (i.e., the tubes 572-2 to 572-7).

The magnitude of the imbalance vector if the tube 572-1 was placed in the rotor position 452-2 was \sqrt{−0.14642+0.3536²}=0.3827.

Secondly, the magnitude of the imbalance vector if the tube 572-1 was placed in the rotor position 452-3 and the remaining tubes were placed in the other empty rotor positions was determined.

$$x = 4 + 0 + 4.5 ( \frac{1}{\sqrt{2}} - \frac{1}{\sqrt{2}} - 1 - \frac{1}{\sqrt{2}} + 0 + \frac{1}{\sqrt{2}} ) = - 0.5 , \\ y = 0 + 5 + 4.5 ( \frac{1}{\sqrt{2}} + \frac{1}{\sqrt{2}} + 0 - \frac{1}{\sqrt{2}} - 1 - \frac{1}{\sqrt{2}} ) = 0.5 .$$

The magnitude of the imbalance vector was thus 0.7071.

Similar calculations gave the magnitudes of the imbalance vectors of 0.9239 and 1.0000 for the rotor positions 452-4 and 452-5, respectively.

Based on these calculations, it was determined that the minimum magnitude of the imbalance vector is estimated to be achieved when the tube 572-1 was placed in the rotor position 452-2. Thus, the tube 572-1 was placed in the rotor position 452-2.

In a next step, the tube 572-2 was removed by the transport unit 300 from the tube rack 570.

In a next step, the weight of the tube 572-2 was determined. The weight of the tube 572-2 was 4 grams.

In a next step, the remaining weight 552 of the five remaining tubes 572-3 to 572-7 was received by the computing device 200. The remaining weight 552 of the five remaining tubes 572-3 to 572-7 was 23 grams.

In a next step, the average weight of the five remaining tubes 572-3 to 572-7 was determined by the computing device 200 based on the remaining weight 552. The average weight of the five remaining tubes was 4.6 grams. Therefore, each of the five remaining tubes was estimated to weigh 4.6 grams.

In a next step, the computing device 200 determined a corresponding rotor position for the tube 572-2 based on the weight of the tube 572-2, the weights of the tubes 582-1, 572-1, and the average weight of the five remaining tubes 572-3 to 572-7.

Since the tubes 582-1, 572-1 placed in the rotor positions 452-1 and 452-2, respectively, had different weights, symmetry was not used and the magnitude of the imbalance vector was estimated for 572-2 in each of the rotor positions 452-3 to 452-8.

The calculations to determine the magnitude of the imbalance vector were same as above, except that there were two terms for the two tubes (i.e., the tubes 582-1, 572-1) within the rotor 450, one term for the tube about to be placed (i.e., the tube 572-2), and five terms for the remaining tubes (i.e., the tubes 572-3 to 572-7).

The magnitudes of the imbalance vectors were 0.4485, 0.1774, 0.4000, 0.7152, 0.9381, and 1.0246 for the rotor positions 452-3 to 452-8, respectively. The rotor position 452-4 had the least estimated magnitude of the imbalance vector, so the tube 572-2 was placed in the rotor position 452-4.

Similarly, the tube 572-3 weighing 4 grams was removed from the tube rack 570. The average weight of the four remaining tubes was 4.75 grams. The estimated magnitudes of the imbalance vectors for the rotor positions 452-3, 452-5, 452-6, 452-7, and 452-8 were 1.1044, 0.7906, 0.5185, 0.3988, and 0.5999, respectively. Thus, the tube 572-3 was placed in the rotor position 452-7.

Then the tube 572-4 weighing 3 grams was removed from the tube rack 570. The average weight of the three remaining tubes was 5.33 grams. The estimated magnitudes of the imbalance vectors for the rotor positions 452-3, 452-5, 452-6, and 452-8 were 2.2667, 1.7141, 2.0749 and 1.5147, respectively. Thus, the tube 572-4 was placed in the rotor position 452-8.

Next, the tube 572-5 weighing 5 grams was removed from the tube rack 570. The average weight of the two remaining tubes was 5.5 grams. The estimated magnitudes of the imbalance vectors for the rotor positions 452-3, 452-5, and 452-6 were 1.3531, 1.8445 and 1.5219, respectively. Thus, the tube 572-5 was placed in the rotor position 452-3.

Next, the tube 572-6 weighing 5 grams was removed from the tube rack 570. The average weight of the one remaining tube was the weight of the remaining tube 572-6, i.e., 6 grams. Since there are only two remaining tubes, and their weight is known, a model was not needed to estimate their weight. The magnitudes of the imbalance vectors were calculated for the rotor positions 452-5 and 452-6 as 1.9791 and 0.8632, respectively. Thus, the tube 572-6 was placed in the rotor position 452-6, and the tube 572-7 was placed in the rotor position 452-5.

This example however did not utilize the lower and upper weight limits 562, 564 (shown in FIG. 8), which may also be known to the computing device 200 (shown in FIG. 1). Using the lower and upper weight limits 562, 564 allows more realistic estimated weights since it is not likely that the weights of each of the remaining tubes are identical and equal to the average of their weights.

### Example 2

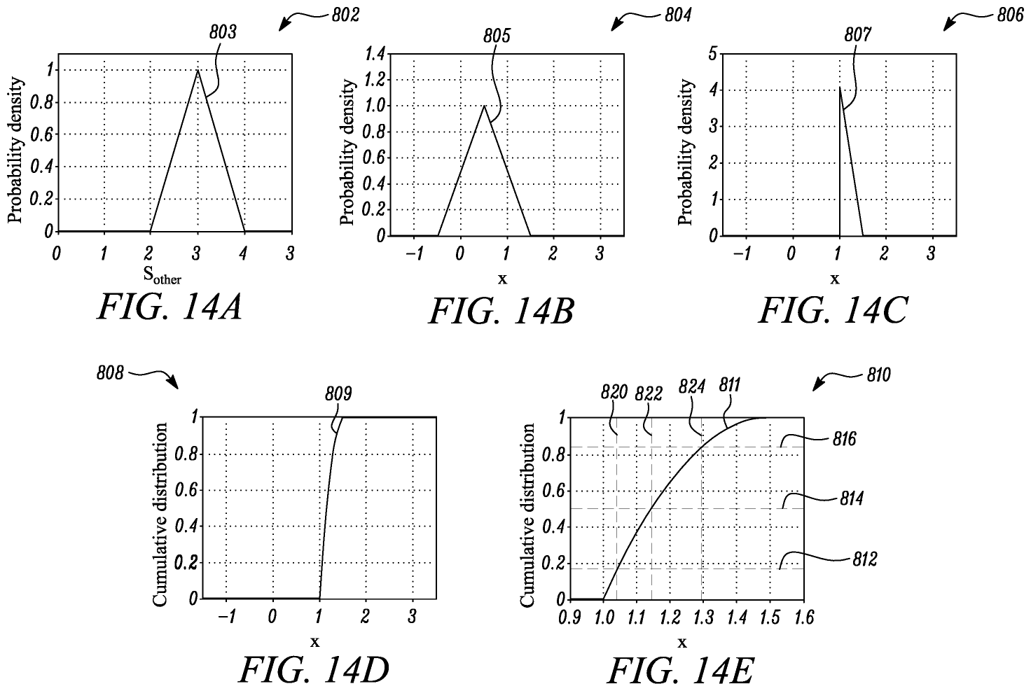

In this example, the estimated balancing parameter 556 of each of the plurality of remaining tubes 510 is based on a statistical model. In this example, a Bayesian model is used. However, any other suitable statistical model may be used, as per desired application attributes. This example will further be described with reference to FIGS. 8 and 14A-14E.

In this example the estimated balancing parameter 556 of each of the plurality of remaining tubes 510 was determined further based on the lower weight limit 562 and the upper weight limit 564 of each of the plurality of tubes 572.

Specifically, in this example, the probability distribution of the balancing parameter 554 of each of the plurality of remaining tubes 510 was determined based at least on the remaining weight 552, the lower weight limit 562 of the corresponding remaining tube, and the upper weight limit 564 of the corresponding remaining tube.

An exemplary method to determine the probability distribution and the estimated weight for each of the remaining tubes 510 is provided for reference below. In this example, there were three remaining tubes 510. Further, each of the three remaining tubes 510 had the lower and upper weight limits 562, 564 of 1 and 2 grams, respectively. Furthermore, the remaining weight 552 of the three remaining tubes 510 was 3.5 grams.

x was a weight of a corresponding tube from the three remaining tubes 510, and S was the remaining weight 552.

In order to determine P(x|S) (i.e., the probability of x, given S), which is the probability distribution of weights of the three remaining tubes 510, Bayes' rule gives:

$$P ( x \vert S ) = \frac{P ( S \vert x ) P ( x )}{P ( S )} . \qquad ( 1 )$$

P(x) is the “prior” probability distribution of x; that is, the probability distribution we assume before we have any other information. Further, for this example, it was assumed that the probability distribution between the lower and upper weight limits 562, 564 was uniform. The denominator was ignored to form the probability distribution of x, given a particular value of S. The denominator could be ignored because the probability distribution was normalized later. Therefore, P(x|S) is directly proportional to the numerator as given below:

$$P ( x \vert S ) ∝ P ( S \vert x ) P ( x ) . \qquad ( 2 )$$

Since for this example we assumed that P(x) had the uniform probability distribution, and since the probability distribution was normalized later, we removed P(x), with the restriction that x must remain within the lower and upper weight limits 562, 564. This gives:

$$P ( x \vert S ) ∝ P ( S \vert x ) . \qquad ( 3 )$$

Further, Sₒₜₕₑᵣ was the remaining weight of the remaining tubes 510 except for the corresponding tube whose weight was x. Then Sₒₜₕₑᵣ=S−x, and so Equation 2 can be rewritten as:

$$P ( x \vert S ) ∝ P ( {S}_{other} = S - x \vert x ) . \qquad ( 4 )$$

Because the weights of the corresponding tube and the other remaining tubes are independent of each other, a probability distribution of Sₒₜₕₑᵣ is independent of x. The probability distribution of Sₒₜₕₑᵣ can be obtained by convolving the probability distribution of each of the other remaining tubes with each other.

For instance, FIG. 14A illustrates a plot 802 comprising a curve 803 of the probability distribution of Sₒₜₕₑᵣ obtained by convolving the probability distributions of two other remaining tubes with each other. Each tube of the two other remaining tubes had a uniform distribution between the lower and upper weight limits 562, 564 of 1 and 2 grams, respectively. As discussed above, S=3.5 grams.

As is apparent from the plot 802, the uniform distribution is constrained to be between the sum of the lower weight limits 562 (i.e., 1+1=2) and the sum of the upper weight limits 564 (i.e., 2+2=4).

However, Equation 4 required the probability distribution of x, not of Sₒₜₕₑᵣ.

Using x=S−Sₒₜₕₑᵣ, the desired probability distribution was obtained as the mirror image of the probability distribution as a function of Sₒₜₕₑᵣ, offset to the right by S.

For instance, FIG. 14B illustrates a plot 804 comprising a curve 805 of the probability distribution of x which is obtained using S−Sₒₜₕₑᵣ (3.5−2=1.5 and 3.5−4=−0.5).

Therefore, as shown FIG. 14B, the probability distribution covered values of x between −0.5 and 1.5. However, as discussed above, the lower and upper weight limits 562, 564 were 1 and 2 grams, respectively. Thus, only the portion of the probability distribution of x between 1 and 2 was used.

FIG. 14C illustrates a plot 806 comprising a curve 807 of the portion of the probability distribution of x after normalization, i.e., between the lower and upper weight limits 562, 564.

As is apparent from FIG. 14C, the curve 807 is skewed to the left. This is because the remaining weight 522 was 3.5 and the sum of the lower and upper weight limits 562, 564 of the remaining tubes 510 were 3 and 6, respectively. Since the remaining weight 522 was closer to the lower weight limit 562, the estimated weight of each of the remaining tubes 510 is more likely to be closer to the lower weight limit 562 than the upper weight limit 564.

FIG. 14D illustrates a plot 808 comprising a curve 809 of a cumulative distribution of x, corresponding to the probability distribution of x shown in FIG. 14C.

In a next step, the set of fractiles of the probability distribution of x was determined.

The estimated weight of each of the remaining tubes 510 can be estimated as appropriate fractiles of the cumulative distribution of the probability distribution.

In this example, the appropriate fractiles were determined using probability fractions,

$${f}_{i} = \frac{0.5 + i}{n} ( i = 0 , 1 , … , n - 1 ) \qquad ( 4 )$$

Further, as there were three remaining tubes in this example, n=3.

Therefore, the probability fractions were 0.1667, 0.5, and 0.8333.

FIG. 14E illustrates a plot 810 comprising a curve 811. The curve 811 is same as the curve 809. In other words, the curve 811 depicts the cumulative distribution of x, corresponding to the probability distribution of x shown in FIG. 14C. The plot 810 further comprises horizontal lines 812, 814, and 816 and vertical lines 820, 822, and 824.

The horizontal lines 812, 814, and 816 depict the probability fractions. Further, the vertical lines 820, 822, and 824 intersect the curve 811 (i.e., the cumulative distribution) at the horizontal lines 812, 814, and 816 (i.e., the probability fractions), respectively. The vertical lines 820, 822, and 824 depict the fractiles of the cumulative distribution of x corresponding to the probability fractions. The fractiles correspond to the set of estimated weights. In this example, the set of estimated weights comprises 1.043, 1.146, and 1.295 grams, respectively.

The set of estimated weights corresponding to the set of fractiles were used for computing imbalance vectors.

Further, at a next step, a plurality of permutations corresponding to a plurality of possible placements of the four tubes within the rotor 450 were created, such that each permutation comprised a corresponding set of rotor positions for the four tubes.

At a next step, an imbalance vector for each of the plurality of permutations based on a weight of the removed tube, the set of estimated weights of each of the three remaining tubes, and the corresponding set of rotor positions for the four tubes was determined.

At a next step, the imbalance vector with a minimum magnitude, and the corresponding rotor position 558 for the removed tube was selected from the corresponding set of rotor positions of the permutation corresponding to the imbalance vector with the minimum magnitude.

At a next step, the removed tube was placed in the corresponding rotor position 558 within the rotor 450.

### Example 3

In this example, using the method of above example (Example 2), the set of estimated weights was determined. Further, as there were multiple values of the magnitude of the imbalance vector produced by the possible placement of the plurality of tubes 572 within the rotor 450, a set of the magnitudes of the imbalance vectors for the plurality of permutations corresponding to a particular rotor position for the removed tube was isolated. Specifically, a particular rotor position for the removed tube resulted in multiple permutations. The plurality of permutations corresponding to a particular rotor position for the removed tube was isolated. The set of magnitudes of the imbalance vectors for the plurality of permutations was also similarly identified. This process was repeated for the rest of the possible rotor positions of the removed tube.

Further, for a given rotor position, a weighted average of the magnitudes of the imbalance vectors from the set of the magnitudes of the imbalance vectors was computed with weights decreasing with increasing magnitude of the imbalance vector. This was repeated for the rest of the possible rotor positions of the removed tube. In this example, each weight was the inverse of the magnitude of the imbalance vector, i.e., determined by the equation provided below:

$$weight = \frac{1}{magnitude of the imbalance vector} \qquad ( 5 )$$

At a next step, a corresponding rotor position was selected based on the smallest weighted average of the magnitudes of the imbalance vectors. In other words, the rotor position that resulted in the smallest weighted average of the magnitudes of the imbalance vectors was selected. Subsequently, the removed tube was placed in the selected rotor position.

### Comparative Performance of Examples 1 to 3

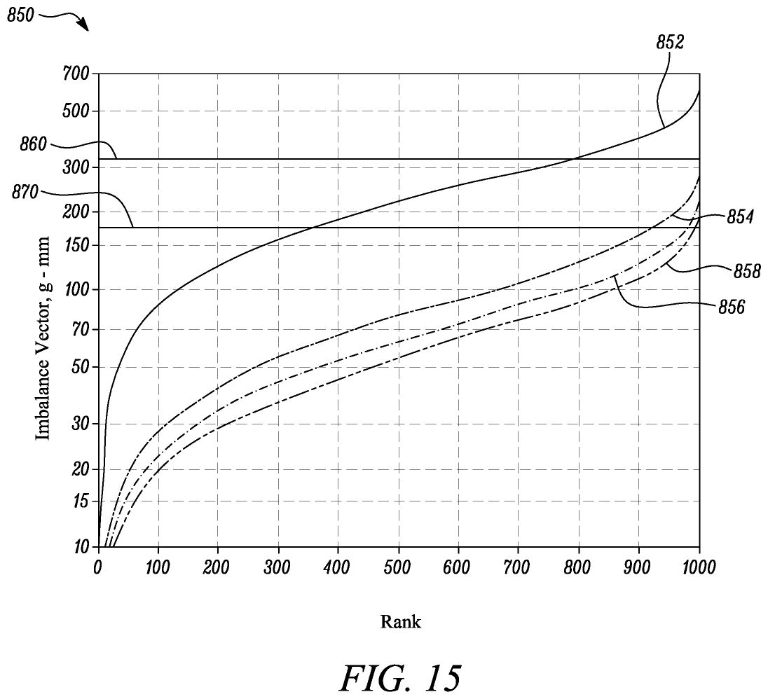

FIG. 15 illustrates a plot 850 depicting performances of the three methods described above with reference to Examples 1 to 3 to select the corresponding rotor position 558 of the tube 572 removed by the transport unit 300. A Monte-Carlo simulation was used to evaluate the performance of the three methods. The Monte-Carlo simulation used 13×75 mm tubes having random weights uniformly distributed between 1.9 and 5.3 grams

A magnitude of an imbalance vector is depicted in gram millimeters (g-mm) on the ordinate axis, and a number of trials is depicted on the abscissa. The ordinate axis used a logarithmic scale, while the abscissa used a linear scale. 1000 trials were conducted for randomly generated sets of 8 tubes and evaluated. The results of the magnitudes of the imbalance vectors were sorted and ranked from low to high, and then plotted.

The plot 850 comprises a curve 852 depicting the resulting magnitudes of imbalance vectors when there was no attempt to balance the centrifuge 400. In other words, the tubes were placed in the order they were placed in a tube rack (e.g., the tube rack 570).

The plot 850 comprises a curve 854 depicting the resulting magnitudes of imbalance vectors when the method of Example 1 was used to balance the centrifuge 400.

The plot 850 comprises a curve 856 depicting the resulting magnitudes of imbalance vectors when the method of Example 2 was used to balance the centrifuge 400.

The plot 850 comprises a curve 858 depicting the resulting magnitudes of imbalance vectors when the method of Example 3 was used to balance the centrifuge 400.

As is apparent from the curves 854, 856, and 858, the method of Example 1 significantly reduced the magnitudes of imbalance vectors as compared with no attempt to balance the centrifuge 400. Specifically, the method of Example 1 reduced the magnitudes of the imbalance vectors by over 50% as compared to no attempt to balance the centrifuge 400.

Further, the method of Example 2 further reduced the magnitudes of imbalance vectors. Furthermore, the method of Example 3 further reduced the magnitudes of imbalance vectors.

The plot 850 further comprises a line 860 depicting an imbalance acceptance limit. In some cases, the centrifuge 400 may have an acceptance limit for a degree of imbalance. The imbalance acceptance limit may vary for different types or sizes of the centrifuges 400.

The plot 850 further comprises a line 870 depicting 50% of the imbalance acceptance limit.

As is apparent from the curves 854, 856, 858 and the lines 860, 870, when there was no attempt to balance the centrifuge 400, the resulting magnitude of imbalance vector of about 19% of the trials exceeded the acceptance limit. Further, the resulting magnitude of imbalance vector of about 69% of the trials exceeded 50% of the acceptance limit.

Further, when the methods of Examples 1-3 were used to balance the centrifuge 400, the resulting magnitude of imbalance vector of none of the trials exceeded the imbalance acceptance limit. Further, the resulting magnitude of imbalance vector of less than about 10% of the trials exceeded 50% of the acceptance limit.

### Example 4

In the above Examples 1-3, the tubes 502 to be placed within the rotor 450 were of a single tube type. However, in some cases, the tubes 502 to be placed within the rotor 450 may be of different tube types.

Since, the different tube types may have different geometries, the center of gravity of the tubes 502 of different tube types may vary considerably.

In such cases, estimated moments of the tubes to be placed are determined instead of the estimated weights.

The weight of the remaining tubes 510 is known and can be determined by using any methods known in the art (for example, based on the difference between the pre-tube removalweight 551 of the tube rack 550 and the weight of the tube 502 removed from the tube rack 550). However, the sum of moments of the remaining tubes 510 may not be determined in such a manner.

In this example, the sum of moments of the remaining tubes 510 was determined based on the following method.

S⁺ and S₋ were the sum of the upper and lower weight limits 562, 564 of the remaining tubes 510, respectively. As discussed above, S was the remaining weight 552 of the remaining tubes 510.

Further,

$$f = \frac{S - {S}_{-}}{{S}_{+} - {S}_{-}}$$

was calculated.

The upper and lower moment limits of the remaining tubes 510 were determined based on the upper and lower weight limits 562, 564 and the geometry 566 of the remaining tubes 510.

M₊ and M₋ were the sum of the upper and lower moment limits of the remaining tubes 510.

The sum of the moments of the remaining tubes 510 was estimated as M=M₋+f(M₊−M₋).

Further, the probability distribution of the moments of the remaining tubes 510 was modeled similarly as described in Example 2.

However, the makeup of the “other” tubes depends on the tube being selected for x. One probability distribution corresponding to each of the tubes being selected for x was computed. Further, a combined probability distribution as the average of the individual probability distributions was calculated. The moments of the remaining tubes 510 were estimated as the fractiles of the combined probability distribution.

### Example 5

The estimated balancing parameters 556 may include a table of previous weights of the tubes 552. For instance, tube types A, B and C may have been previously run. The table may comprise a sub-table for each of the tube types. A history of the weights of each tube type would be stored in each of the sub-tables. For example, each of the sub-tables may record the last 100 weights of the tubes of the corresponding tube type. When one of the tubes 552 is picked up and its weight is determined, the type of each of the remaining tubes 510 will be known. The estimated balancing parameter for each of the remaining tubes may be based on at least the tube weights stored in the corresponding sub-table. For example, an average of the weights contained in the corresponding sub-table may be computed, and the estimated balancing parameter could be based on at least the average of the weights.

As another example, each sub-table may comprise an exponentially weighted average of the weights of the tubes of the corresponding type.

The weights incorporated in the table could include weights from previous centrifuge runs. They could also include weights from other centrifuges. Including a large number of weights could make the estimated balancing parameters 556 more accurate for the particular laboratory.

### Example 6

It was also observed that the order in which tubes of differing tube types are removed from the tube rack 550 to be placed within the rotor 450 also affected the resulting magnitudes of imbalance vectors.

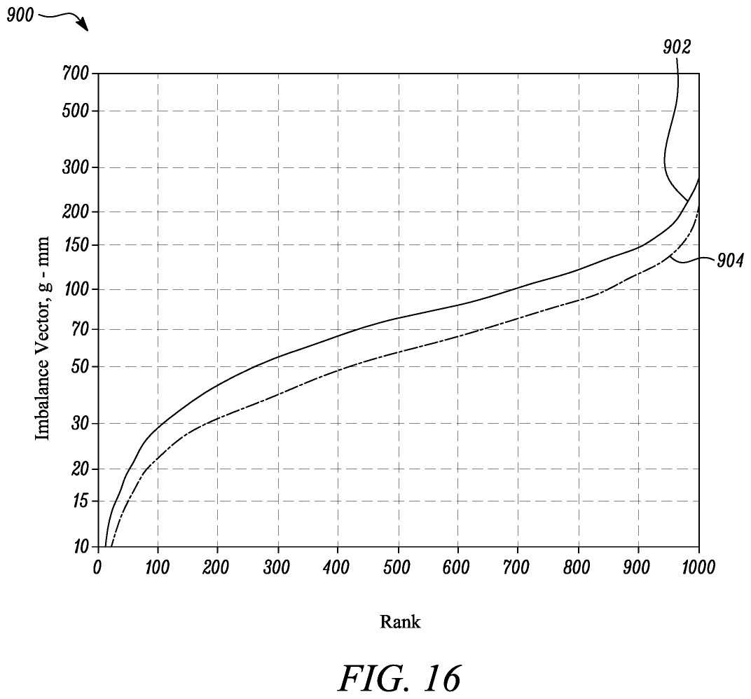

FIG. 16 illustrates a plot 900 depicting the resulting magnitudes of imbalance vectors when the seven tubes of type A and one tube of type B were placed.

A magnitude of an imbalance vector is depicted in gram millimeters (g-mm) on the ordinate axis, and a number of trials is depicted on the abscissa. The ordinate axis used a logarithmic scale, while the abscissa used a linear scale. 1000 trials were conducted for randomly generated sets of 8 tubes and evaluated. In this example, there were seven tubes of the tube type A and one tube of the tube type B. In this example, the tube type A has dimensions of 13×75 mm, and the tube type B has dimensions of 10×100 mm. The tube types A and B have volume limits of 1.8-5.0 mL and 3.5-7.0 mL, respectively. So, the tubes of the tube type B are generally heavier than the tubes of the tube type A.

Plot 900 comprises a curve 902 depicting the resulting magnitudes of imbalance vectors when the seven tubes of the tube type A were placed first, followed by the one tube of the tube type B.

Plot 900 comprises a curve 904 depicting the resulting magnitudes of imbalance vectors when the one tube of the tube type B was placed first, followed by the seven tubes of the tube type A.

As is apparent from the curves 902 and 904 of the plot 900, the resulting magnitudes of imbalance vectors were substantially reduced when the one tube of the tube type B was placed first, followed by the seven tubes of the tube type A.

Therefore, the methods of balancing the centrifuge according to the present disclosure performed best when the tube types with the smallest number of tubes 502 are placed first, and the tube type having the largest number of tubes 502 is placed last.

### Example 7

It was observed that even when the tubes are all of the same type, the algorithm described herein reduces the imbalance when compared to placing the tubes at random.

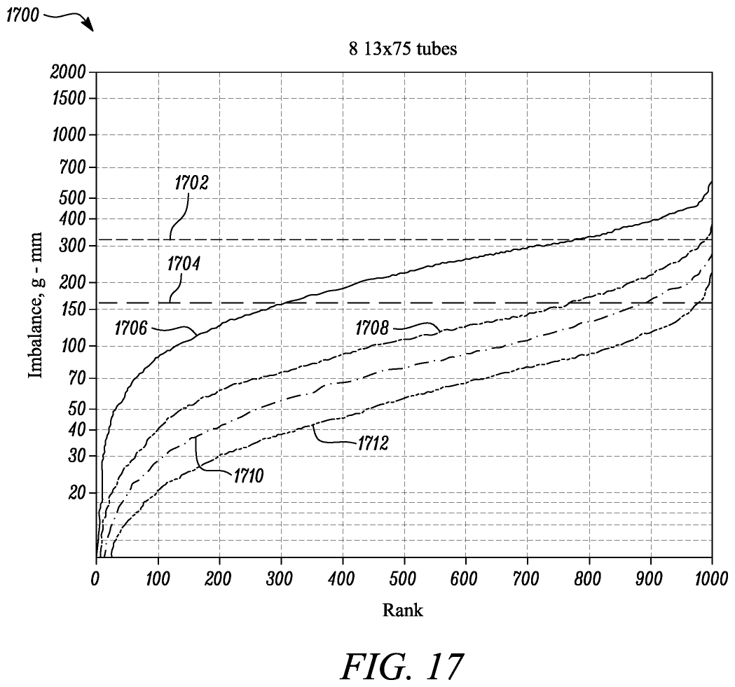

FIG. 17 illustrates a plot 1700 that shows the results of applying various algorithms to 1000 sets of randomly-chosen tube weights. The tube weights were drawn from a uniform distribution between the lower and upper weight limits. The algorithms are: 1) no optimization 1706, 2) use only the tube types, as described above 1708, 3) use the rack weight 1710, and estimate the unknown weights, but without using a statistical model, and 4) use a statistical model 1710, and employ a weighted average of the imbalances. An overall performance metric was calculated using mean (imbalance⁴)^{0.25}. (This formula assumes the harm from imbalance is proportional the 4^{th} power of the imbalance.) Furthermore, the percentage of trials which exceeded the imbalance specification of 320 g-mm, or 50% of the specification was determined. The plot 1700 further comprises a line 1702 depicting an imbalance acceptance limit and a line 1704 depicting 50% of the imbalance acceptance limit.

Table 1 lists these performance metrics. It shows that, even without the rack weights, the algorithm reduces the imbalance to about 56% of it unoptimized level. Adding the rack weight decreases the imbalance to about 42% of the unoptimized level; the full optimization achieves 30%. Though being unable to use the rack weights does not allow the best performance, the centrifuge balancing algorithm allows for a significant reduction in imbalance. Notably, the fraction of trials wherein the imbalance exceeded the specification dropped from 21% to 1%. This disproves the original supposition that the balancing algorithm would be ineffective without the rack weights.

TABLE 1
Performance of various centrifuge balancing algorithms in loading 8
13 × 75 tubes.

| | Imbalance | Fraction | Fraction over |
|---|---|---|---|
| Algorithm | metric | over spec | 50% spec |
| No optimization | 301 | 21% | 69% |
| Tube type | 169 | 1% | 23% |
| Tube type + rack | 127 | 0% | 11% |
| weight | | | |
| Statistical model + | 93 | 0% | 2% |
| weighted average | | | |

### Example 8

The advantages of using the centrifuge balancing algorithm are even greater when a mixture of tube types are to be loaded. A simulation was performed with 2 13×75 tubes, and 3 each of 10×100 and 16×100 tubes. These tubes have very different weight ranges. The 13×75 tubes weigh 9.2-12.6 grams; 10×100 weigh 12.3-16.0 g, and 16×100 weigh 18.5-22.1 g. Because of the disparity in weights, there is much more potential for imbalance.

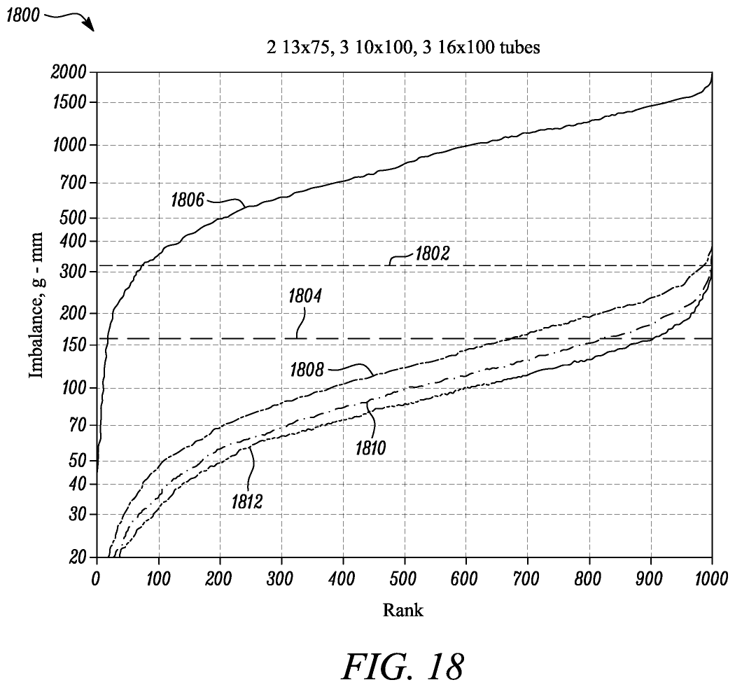

FIG. 18 illustrates a plot 1800 that shows the imbalance using several algorithms. In the previous example, all the tubes were of the same type, so it does not matter in which order the tubes are picked up from the rack. However, in the present example, the tubes are of different types, so the order in which the tubes are picked up affects the balancing performance. In general, it appears that all the tubes of one type should be picked first, then the tubes of a second type, etc. All the tubes of one type should be picked before proceeding to another tube type. Further, it is advantageous to pick up the tubes having the type with the lowest tube count first. In the present example there are only 2 13×75 tubes, compared with 3 of the other types, so the 13×75 tubes are picked. In this example, five algorithms were compared: 1) no optimization 1806, 2) no rack weight, pick tubes in the same order they appear in the rack 1808, 3) no rack weight, pick tubes group by group, with smallest group first 1810; 4) Use rack weight 1812; 5) use statistical model and weighted averaging. In this example, algorithms 4 and 5 had almost identical performance so algorithm 5 is not shown in plot 1800. The plot 1800 further comprises a line 1802 depicting an imbalance acceptance limit and a line 1804 depicting 50% of the imbalance acceptance limit.

Table 2 shows the same algorithm performance metrics as shown by Table 1. Without a balancing algorithm, the imbalance is very severe, being over spec 92% of the trials, and often far outside of spec. The centrifuge would fail to operate in this environment. Many runs would be halted, defeating automation. Utilizing the tube types brings a huge improvement, and picking the tubes, grouping by tube type brings further improvement—the imbalance metric is only 13% of the unoptimized metric. Surprisingly, the imbalance is slightly better with this mixture of tube types than when using the same algorithm where all the tubes are the same type-compare Table 1 “tube type”. Using the rack weight brings more improvement-both examples perform very similarly. However, the statistical model does not bring additional benefit with this specific mixture of tube types.

TABLE 2
Performance of various centrifuge balancing algorithms in loading
a mixture of tube types (2 13 × 75 tubes, 3 each of 10 × 100 and
16 × 100 tubes).

| | Imbalance | Fraction | Fraction over |
|---|---|---|---|
| Algorithm | metric | over spec | 50% spec |
| No optimization | 1088 | 92% | 98% |
| Tube type | 180 | 1% | 32% |
| Tube type, best | 143 | 0.2% | 17% |
| tube order | | | |
| Tube type + rack | 129 | 0.2% | 9% |
| weight | | | |
| Statistical model + | 129 | 0.1% | 9% |
| weighted average | | | |

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A method (600) for balancing a centrifuge (400) having a rotor (450), the method (600) comprising:
a) removing (602), by a transport unit (300), a tube (572) from a plurality of tubes (572) from a tube rack (570) configured to removably hold the plurality of tubes (572);
b) determining (602) a weight of the tube (572) which has been removed from the tube rack (570);
c) determining (606), by a computing device (200), a balancing parameter (554) of the tube (572);
d) determining (608), by the computing device (200), an estimated balancing parameter (556) of each of a plurality of remaining tubes (510) from the plurality of tubes (572) in the tube rack;
e) determining (610), by the computing device (200), a corresponding rotor position (558) from a plurality of rotor positions (452) within the rotor (450) for the tube (572) based at least on: the balancing parameter (554) of the tube (572), the balancing parameters (554) of previously placed tubes (572) from the plurality of tubes (572) placed within the rotor (450), and the estimated balancing parameter (556) of each of the plurality of remaining tubes (510); and
f) placing (612), by the transport unit (300), the tube (572) in the corresponding rotor position (558) within the rotor (450).

2. The method (600) of claim 1, further comprising determining one or both of a post-tube removal weight (553) of the tube rack (570) after the tube (572) has been removed from the tube rack (570) and a remaining weight (552) of the plurality of remaining tubes (510).

3. The method (600) of claim 2, wherein determining the remaining weight (552) comprises determining a difference between the post-tube removal weight (553) of the tube rack (570) after the tube (572) has been removed from the tube rack (570), and a weight of an empty tube rack (505).

4. The method (600) of claim 2, wherein determining the remaining weight (552) after the tube (572) is removed comprises determining a difference between the remaining weight (552) before the tube (572) is removed, and the weight of the tube (572).

5. The method (600) of claims 1 to 4, wherein the weight of the tube (572) is determined as a difference between a post-tube removal weight (553) of the tube rack (570) after the tube (572) has been removed, and a pre-tube removal weight (551) of the tube rack (570) before the tube (572) has been removed.

6. The method (600) of claims 1 to 5, wherein the weight of the tube (572) is determined without directly measuring the weight of the tube (572).

7. The method (600) of any of claims 1 to 6, wherein the weight of the tube (572) is determined by the transport unit (300).

8. The method (600) of any of claims 1 to 7, further comprising, receiving (608), at the computing device (200), a remaining weight (552) of the plurality of remaining tubes (510).

9. The method (600) of any of claims 1 to 8, wherein the balancing parameter (554) comprises the weight of the tube (572), wherein determining the estimated balancing parameter (556) of each of the plurality of remaining tubes (510) further comprises determining an average weight of the plurality of remaining tubes (510) based on a count of the plurality of remaining tubes (510) and the remaining weight (552) of the plurality of remaining tubes (510) in the tube rack (570), and wherein the estimated balancing parameter (556) of each of the plurality of remaining tubes (510) comprises the average weight of the plurality of remaining tubes (510).

10. The method (600) of any of claims 1 to 9, wherein determining the corresponding rotor position (558) within the rotor (450) for the tube (572) further comprises minimizing an estimated magnitude of an imbalance vector produced by a possible placement of the plurality of tubes (572) within the rotor (450).

11. The method (600) of claim 10, wherein minimizing the estimated magnitude of the imbalance vector further comprises:
creating a plurality of permutations corresponding to a plurality of possible placements of the plurality of tubes (572) within the rotor (450), wherein each permutation comprises a corresponding set of rotor positions for the plurality of tubes (572);
determining the imbalance vector for each of the plurality of permutations based at least on the balancing parameter (554) of the tube (572), the balancing parameters (554) of the previously placed tubes (572) from the plurality of tubes (572) placed within the rotor (450), the estimated balancing parameter (556) of each of the plurality of remaining tubes (510), and the corresponding set of rotor positions for the plurality of tubes (572); and
selecting a corresponding rotor position (558) that minimizes the estimated magnitude of the imbalance vector.

12. The method (600) of claim 11, wherein selecting the corresponding rotor position (558) that minimizes the estimated magnitude of the imbalance vector further comprises selecting a permutation corresponding to the imbalance vector which has a minimum magnitude.

13. The method (600) of claim 11, wherein selecting the corresponding rotor position (558) which minimizes the estimated magnitude of the imbalance vector further comprises:
creating a group of a plurality of permutations for each corresponding rotor position (558) such that all of the plurality of permutations in each of the groups share a same corresponding rotor position (558);
determining the estimated magnitude of the imbalance vector for each group, based on at least the imbalance vectors of the permutations contained in the group.

14. The method (600) of claim 13, wherein the estimated magnitude of the imbalance vector for each group is based on at least a weighted average of the magnitudes of the imbalance vectors of the permutations in the group.

15. The method (600) of claim 13, wherein the estimated magnitude of the imbalance vector for each group is based on at least a weighted vote, wherein the weighted vote is based on at least a rank of the magnitude of the imbalance vectors.

16. The method (600) of any of claims 1 to 15, wherein the weight of the tube (572) is determined as a difference between a post tube removal weight (553) of the tube rack (570) after the tube (572) has been removed, and a pre-tube removal weight (551) of the tube rack (570) before the tube (572) has been removed.

17. The method (600) of claims 1 to 16, wherein the weight of the tube (572) is determined by at least one sensor (330) in a pick-and-place device (310).

18. The method (600) of any of claims 1 to 17, wherein determining the estimated balancing parameter (556) of each of the plurality of remaining tubes (510) is based on a statistical model.

19. The method (600) of any of claims 1 to 18, further comprising, receiving, by the computing device (200), a lower weight limit (562) and an upper weight limit (564) of each of the plurality of tubes (572), determining the estimated balancing parameter (556) of each of the plurality of remaining tubes (510) is further based on the lower weight limit (562) and the upper weight limit (564) of each of the plurality of tubes (572).

20. The method (600) of any of claims 1 to 19, wherein determining the estimated balancing parameter (556) of each of the plurality of remaining tubes (510) is further based on a remaining weight (552) of the plurality of remaining tubes (510) in the tube rack.

21. The method (600) of any of claims 1 to 20, wherein the estimated balancing parameter (556) of each of the plurality of remaining tubes (510) is based on a mean of an upper weight limit (564) and a lower weight limit (562).

22. The method of any of claims 19 to 21, wherein one or both of the upper weight limit (564) and the lower weight limit (562) is based on one or more types of tubes of the plurality of tubes (572).

23. The method (600) of any of claims 1 to 22, wherein the estimated balancing parameter (556) of each of the plurality of remaining tubes (510) is based on at least a record of tube weights of the tubes (552) of corresponding tube types which were previously picked up by a transport unit (300).

24. The method (600) of any of claims 1 to 23, wherein the estimated balancing parameter (556) of each of the plurality of remaining tubes (510) is based at least on predetermined representative weights of the corresponding tube types.

25. The method (600) of any of claims 1 to 24, further comprising:
determining a remaining weight (552) of the plurality of remaining tubes (510) after the tube (572) has been removed from the tube rack (570),
wherein determining the estimated balancing parameter (556) of each of the plurality of remaining tubes (510) further comprises:
determining a probability distribution of the balancing parameter (554) of each of the plurality of remaining tubes (510) based at least on the remaining weight (552) of the plurality of remaining tubes (510) in the tube rack (570), a lower weight limit (562) of the corresponding remaining tube, and an upper weight limit (564) of the corresponding remaining tube;
determining a combined probability distribution based on the probability distribution of the balancing parameter (554) of each of the plurality of remaining tubes (510);
determining a set of fractiles of the combined probability distribution; and
determining a set of estimated balancing parameters of the plurality of remaining tubes (510) based on the set of fractiles and the combined probability distribution, wherein the set of estimated balancing parameters comprises the estimated balancing parameter (556) of each of the plurality of remaining tubes (510).

26. The method (600) of any of claims 1 to 25, wherein the balancing parameter (554) comprises the weight of the tube (572), and wherein the estimated balancing parameter of each of the plurality of remaining tubes (510) comprises an estimated weight of the corresponding remaining tube.

27. The method (600) of any of claims 1 to 26, wherein the balancing parameter (554) comprises a moment of the tube (572) when placed within the rotor (450), and wherein the estimated balancing parameter of each of the plurality of remaining tubes (510) comprises an estimated moment of the corresponding remaining tube when placed within the rotor (450).

28. The method (600) of any of claims 1 to 27, wherein determining the estimated balancing parameter (556) of each of the plurality of remaining tubes (510) further comprises receiving, by the computing device (200), a geometry (566) of each of the plurality of tubes (572), and wherein a probability distribution of the balancing parameter (554) of each of the plurality of remaining tubes (510) is determined further based on the geometry (566) of the corresponding remaining tube.

29. The method (600) of any of claims 1 to 28, wherein the balancing parameter (554) of the tube (572) is determined, at least in part, by the transport unit (300).

30. The method (600) of any of claims 1 to 29, further comprising repeating the steps a) to f) until two tubes (572), to be placed in empty rotor positions (452e) from the plurality of rotor positions (452), are remaining in the tube rack (570).

31. The method (600) of any of claims 1 to 30, wherein the plurality of tubes (572) comprises a plurality of tube types comprising a predominant tube type having a maximum number of tubes from the plurality of tubes (572), and wherein the method (600) further comprises placing the tubes of the predominant tube type in empty rotor positions (452e) after placing the tubes (572) not of the predominant tube type in the empty rotor positions (452e).

32. The method (600) of any of claims 1 to 31, wherein the plurality of tubes (572) comprises a plurality of tube types, and the method (600) further comprises:
identifying a plurality of groups of the plurality of tubes (572), such that the tubes within each of the plurality of groups have a same tube type from the plurality of tube types; and
placing the plurality of groups serially within the rotor (450).

33. The method (600) of any of claims 1 to 32, further comprising:
selecting one or more dummy tubes (574) from at least one dummy tube (574); and
placing the one or more dummy tubes (574) in empty rotor positions (452e) from the plurality of rotor positions (452) within the rotor (450).

34. The method (600) of claim 33, wherein the one or more dummy tubes (574) are selected upon determining an undesirable risk that a magnitude of an imbalance vector (592) after placing a last tube (572) will be greater than a predetermined threshold (590).

35. The method (600) of claim 33, wherein placing the one or more dummy tubes (574) results in a magnitude of an imbalance vector (592) being less than a predetermined threshold (590).

36. The method (600) of any of claims 34 to 35, wherein the one or more dummy tubes (574) are selected upon determining that an odd number of the tubes (572) are to be placed in the empty rotor positions (452e), and the rotor (450) comprises an even number of the rotor positions (452).

37. The method (600) of claims 34 to 36, wherein the one or more dummy tubes (574) are selected upon determining that a count of the plurality of tubes (572) to be placed within the rotor (450) is less than a count of the rotor positions (452).

38. The method (600) of any of claims 33 to 37, wherein the plurality of tubes (572) comprises two tubes, and wherein the method (600) further comprises placing two or more of the one or more dummy tubes (574) in the empty rotor positions (452e) upon determining that the two tubes are to be placed in the empty rotor positions (452e).

39. The method (600) of any of claims 33 to 38, wherein the one or more dummy tubes (574) are selected upon determining that the plurality of tubes (572) comprises a plurality of tube types, wherein a first tube type from the plurality of tube types comprises an odd number of the tubes (572), and wherein the first tube type has a first balancing parameter that is substantially different from second balancing parameters of remaining tube types from the plurality of tube types, such that a magnitude of an imbalance vector after placing the plurality of tubes (572) comprising the plurality of tube types is greater than a predetermined threshold (590).

40. The method (600) of any of claims 33 to 39, wherein the one or more dummy tubes (574) are placed in the rotor positions (452) within the rotor (450) after the balance parameters (554) of the plurality of tubes (572) are determined.

41. The method (600) of any of claims 1 to 40, further comprising:
selecting one or more tubes (582) from another tube rack (580) if a count of the plurality of tubes (572) is less than a count of the plurality of the rotor positions (452); and
placing the one or more tubes (582) in one or more empty rotor positions (452e) from the plurality of rotor positions (452) within the rotor (450).

42. The method (600) of any of claims 1 to 41, further comprising placing one or more tubes (582) from an other tube rack (580) within the rotor (450) prior to placing the plurality of tubes (572) from the tube rack (570) within the rotor (450) if a count of the one or more tubes (582) in the other tube rack (580) is less than a count of the plurality of tubes (572) in the tube rack (570).

43. A system (100) for performing the method (600) of any of claims 1 to 42, the system (100) comprising:
the computing device (200); and
the transport unit (300) controlled by the computing device (200).

44. The system (100) of claim 43, wherein the transport unit (300) comprises a pick-and-place device (310), and wherein the pick-and-place device (310) comprises a gripper (320) configured to removably engage at least one of the plurality of tubes (572) and thereby place the at least one of the plurality of tubes (572) within the rotor (450).

45. The system (100) of claim 44, wherein the pick-and-place device (310) comprises at least one sensor (330) configured to determine, at least in part, the balancing parameter (554) of the tube (572).

46. An automated analyzer (500) comprising:
the system (100) of any of claims 41 to 43; and
the centrifuge (400) comprising the rotor (450), the rotor (450) comprising the plurality of rotor positions (452).

47. The automated analyzer (500) of claim 46, wherein the centrifuge (400) comprises a lid (410), and wherein the lid (410) comprises an access opening (412) aligned with one or more of the plurality of rotor positions (452).

48. The automated analyzer (500) of claim 47, wherein the system (100) is configured to rotate the rotor (450), such that the access opening (412) is at least aligned with the corresponding rotor position (558) within the rotor (450).

49. The automated analyzer (500) of any of claims 47 to 48, wherein the transport unit (300) is configured to access the rotor (450) by moving vertically through the access opening (412) to place the tube (572) in the corresponding rotor position (558) within the rotor (450).

50. A computing device (200) for balancing a centrifuge (400) having a rotor (450) comprising:
at least one memory (210) configured to store instructions (212); and
at least one processor (220) capable of executing the instructions (212) to perform the steps of:
a) controlling a transport unit (300) to remove a tube (572) from a plurality of tubes (572) from a tube rack (570) configured to removably hold the plurality of tubes (572);
b) determining (602) a weight of the tube (572) which has been removed from the tube rack (570);
c) determining a balancing parameter (554) of the tube (572);
d) determining an estimated balancing parameter (556) of each of the plurality of remaining tubes (510) based at least on the remaining weight (552) of the plurality of remaining tubes (510) in the tube rack (570);
e) determining a corresponding rotor position (558) from a plurality of rotor positions (452) within the rotor (450) for the tube (572) based at least on the balancing parameter (554) of the tube (572), the balancing parameters (554) of previously placed tubes (572) from the plurality of tubes (572) placed within the rotor (450), and the estimated balancing parameter (556) of each of the plurality of remaining tubes (510); and
f) controlling the transport unit (300) to place the tube (572) in the corresponding rotor position (558) within the rotor (450).

51. The computing device (200) of claim 50, further comprising determining one or both of a post-tube removal weight (553) of the tube rack (570) after the tube (572) has been removed from the tube rack (570) and a remaining weight (552) of the plurality of remaining tubes (510).

52. The computing device (200) of claim 51, wherein determining the remaining weight (552) comprises determining a difference between the post-tube removal weight (553) of the tube rack (570) after the tube (572) has been removed from the tube rack (570), and a weight of an empty tube rack (505).

53. The computing device (200) of claim 51, wherein determining the remaining weight (552) after the tube (572) is removed comprises determining a difference between the remaining weight (552) before the tube (572) is removed, and the weight of the tube (572).

54. The computing device (200) of claims 50 to 53, wherein the weight of the tube (572) is determined as a difference between a post-tube removal weight (553) of the tube rack (570) after the tube (572) has been removed, and a pre-tube removal weight (551) of the tube rack (570) before the tube (572) has been removed.

55. The computing device (200) of claims 50 to 54, wherein the weight of the tube (572) is determined without directly measuring the weight of the tube (572).

56. The computing device (200) of claims 50 to 55 wherein the weight of the tube (572) is determined by the transport unit (300).

57. The computing device (200) of claims 50 to 56, further comprising, receiving (608), at the computing device (200), a remaining weight (552) of the plurality of remaining tubes (510).

58. The computing device (200) of claims 50 to 57, wherein the balancing parameter (554) comprises the weight of the tube (572), wherein determining the estimated balancing parameter (556) of each of the plurality of remaining tubes (510) further comprises determining an average weight of the plurality of remaining tubes (510) based on a count of the plurality of remaining tubes (510) and the remaining weight (552) of the plurality of remaining tubes (510) in the tube rack (570), and wherein the estimated balancing parameter (556) of each of the plurality of remaining tubes (510) comprises the average weight of the plurality of remaining tubes (510).

59. The computing device (200) of claims 50 to 58, wherein determining the corresponding rotor position (558) within the rotor (450) for the tube (572) further comprises minimizing an estimated magnitude of an imbalance vector produced by a possible placement of the plurality of tubes (572) within the rotor (450).

60. The computing device (200) of claim 59, wherein minimizing the estimated magnitude of the imbalance vector further comprises:
creating a plurality of permutations corresponding to a plurality of possible placements of the plurality of tubes (572) within the rotor (450), wherein each permutation comprises a corresponding set of rotor positions for the plurality of tubes (572);
determining the imbalance vector for each of the plurality of permutations based at least on the balancing parameter (554) of the tube (572), the balancing parameters (554) of the previously placed tubes (572) from the plurality of tubes (572) placed within the rotor (450), the estimated balancing parameter (556) of each of the plurality of remaining tubes (510), and the corresponding set of rotor positions for the plurality of tubes (572); and
selecting a corresponding rotor position (558) that minimizes the estimated magnitude of the imbalance vector.

61. The computing device (200) of claim 60, wherein selecting the corresponding rotor position (558) that minimizes the estimated magnitude of the imbalance vector further comprises selecting a permutation corresponding to the imbalance vector which has a minimum magnitude.

62. The computing device (200) of claim 60, wherein selecting the corresponding rotor position (558) which minimizes the estimated magnitude of the imbalance vector further comprises:
creating a group of a plurality of permutations for each corresponding rotor position (558) such that all of the plurality of permutations in each of the groups share a same corresponding rotor position (558);
determining the estimated magnitude of the imbalance vector for each group, based on at least the imbalance vectors of the permutations contained in the group.

63. The computing device (200) of claim 62, wherein the estimated magnitude of the imbalance vector for each group is based on at least a weighted average of the magnitudes of the imbalance vectors of the permutations in the group.

64. The computing device (200) of claim 62, wherein the estimated magnitude of the imbalance vector for each group is based on at least a weighted vote, wherein the weighted vote is based on at least a rank of the magnitude of the imbalance vectors.

65. The computing device of any of claims 50 to 64, wherein the weight of the tube (572) is determined as a difference between a post tube removal weight (553) of the tube rack (570) after the tube (572) has been removed, and a pre-tube removal weight (551) of the tube rack (570) before the tube (572) has been removed.

66. The computing device of any of claims 50 to 65, wherein the weight of the tube (572) is determined by at least one sensor (330) in a pick-and-place device (310).

67. The computing device of any of claims 50 to 66, wherein determining the estimated balancing parameter (556) of each of the plurality of remaining tubes (510) is based on a statistical model.

68. The computing device of any of claims 50 to 67, further comprising, receiving, by the computing device (200), a lower weight limit (562) and an upper weight limit (564) of each of the plurality of tubes (572), determining the estimated balancing parameter (556) of each of the plurality of remaining tubes (510) is further based on the lower weight limit (562) and the upper weight limit (564) of each of the plurality of tubes (572).

69. The computing device of any of claims 50 to 65, wherein determining the estimated balancing parameter (556) of each of the plurality of remaining tubes (510) is further based on a remaining weight (552) of the plurality of remaining tubes (510) in the tube rack.

70. The computing device of any of claims 50 to 69, wherein the estimated balancing parameter (556) of each of the plurality of remaining tubes (510) is based on a mean of an upper weight limit (564) and a lower weight limit (562).

71. The method of any of claims 68 to 70, wherein one or both of the upper weight limit (564) and the lower weight limit (562) is based on one or more types of tubes of the plurality of tubes (572).

72. The computing device of any of claims 50 to 71, wherein the estimated balancing parameter (556) of each of the plurality of remaining tubes (510) is based on at least a record of tube weights of the tubes (552) of corresponding tube types which were previously picked up by a transport unit (300).

73. The computing device of any of claims 50 to 72, wherein the estimated balancing parameter (556) of each of the plurality of remaining tubes (510) is based at least on predetermined representative weights of the corresponding tube types.

74. The computing device of any of claims 50 to 73, further comprising:
determining a remaining weight (552) of the plurality of remaining tubes (510) after the tube (572) has been removed from the tube rack (570),
wherein determining the estimated balancing parameter (556) of each of the plurality of remaining tubes (510) further comprises:
determining a probability distribution of the balancing parameter (554) of each of the plurality of remaining tubes (510) based at least on: the remaining weight (552) of the plurality of remaining tubes (510) in the tube rack (570), a lower weight limit (562) of the corresponding remaining tube, and an upper weight limit (564) of the corresponding remaining tube;
determining a combined probability distribution based on the probability distribution of the balancing parameter (554) of each of the plurality of remaining tubes (510);
determining a set of fractiles of the combined probability distribution; and
determining a set of estimated balancing parameters of the plurality of remaining tubes (510) based on the set of fractiles and the combined probability distribution, wherein the set of estimated balancing parameters comprises the estimated balancing parameter (556) of each of the plurality of remaining tubes (510).

75. The computing device of any of claims 50 to 74, wherein the balancing parameter (554) comprises the weight of the tube (572), and wherein the estimated balancing parameter of each of the plurality of remaining tubes (510) comprises an estimated weight of the corresponding remaining tube.

76. The computing device of any of claims 50 to 75, wherein the balancing parameter (554) comprises a moment of the tube (572) when placed within the rotor (450), and wherein the estimated balancing parameter of each of the plurality of remaining tubes (510) comprises an estimated moment of the corresponding remaining tube when placed within the rotor (450).

77. The computing device of any of claims 50 to 76, wherein determining the estimated balancing parameter (556) of each of the plurality of remaining tubes (510) further comprises receiving, by the computing device (200), a geometry (566) of each of the plurality of tubes (572), and wherein a probability distribution of the balancing parameter (554) of each of the plurality of remaining tubes (510) is determined further based on the geometry (566) of the corresponding remaining tube.

78. The computing device of any of claims 50 to 77, wherein the balancing parameter (554) of the tube (572) is determined, at least in part, by the transport unit (300).

79. The computing device of any of claims 50 to 78, further comprising repeating the steps a) to f) until two tubes (572), to be placed in empty rotor positions (452e) from the plurality of rotor positions (452), are remaining in the tube rack (570).

80. The computing device of any of claims 50 to 79, wherein the plurality of tubes (572) comprises a plurality of tube types comprising a predominant tube type having a maximum number of tubes from the plurality of tubes (572), and wherein the method (600) further comprises placing the tubes of the predominant tube type in empty rotor positions (452e) after placing the tubes (572) not of the predominant tube type in the empty rotor positions (452e).

81. The computing device of any of claims 50 to 80, wherein the plurality of tubes (572) comprises a plurality of tube types, and the method (600) further comprises:
identifying a plurality of groups of the plurality of tubes (572), such that the tubes within each of the plurality of groups have a same tube type from the plurality of tube types; and
placing the plurality of groups serially within the rotor (450).

82. The computing device of any of claims 50 to 81, further comprising:
selecting one or more dummy tubes (574) from at least one dummy tube (574); and
placing the one or more dummy tubes (574) in empty rotor positions (452e) from the plurality of rotor positions (452) within the rotor (450).

83. The computing device of claim 82, wherein the one or more dummy tubes (574) are selected upon determining an undesirable risk that a magnitude of an imbalance vector (592) after placing a last tube (572) will be greater than a predetermined threshold (590).

84. The computing device of any of claim 82, wherein placing the one or more dummy tubes (574) results in a magnitude of an imbalance vector (592) being less than a predetermined threshold (590).

85. The computing device of any of claims 83 to 84, wherein the one or more dummy tubes (574) are selected upon determining that an odd number of the tubes (572) are to be placed in the empty rotor positions (452e), and the rotor (450) comprises an even number of the rotor positions (452).

86. T The computing device of any of claims 83 to 85, wherein the one or more dummy tubes (574) are selected upon determining that a count of the plurality of tubes (572) to be placed within the rotor (450) is less than a count of the rotor positions (452).

87. The computing device of any of claims 82 to 86, wherein the plurality of tubes (572) comprises two tubes, and wherein the method (600) further comprises placing two or more of the one or more dummy tubes (574) in the empty rotor positions (452e) upon determining that the two tubes are to be placed in the empty rotor positions (452e).

88. The computing device of any of claims 82 to 87, wherein the one or more dummy tubes (574) are selected upon determining that the plurality of tubes (572) comprises a plurality of tube types, wherein a first tube type from the plurality of tube types comprises an odd number of the tubes (572), and wherein the first tube type has a first balancing parameter that is substantially different from second balancing parameters of remaining tube types from the plurality of tube types, such that a magnitude of an imbalance vector after placing the plurality of tubes (572) comprising the plurality of tube types is greater than a predetermined threshold (590).

89. The computing device of any of claims 82 to 88, wherein the one or more dummy tubes (574) are placed in the rotor positions (452) within the rotor (450) after the balance parameters (554) of the plurality of tubes (572) are determined.

90. The computing device of any of claims 50 to 89, further comprising:
selecting one or more tubes (582) from another tube rack (580) if a count of the plurality of tubes (572) is less than a count of the plurality of the rotor positions (452); and
placing the one or more tubes (582) in one or more empty rotor positions (452e) from the plurality of rotor positions (452) within the rotor (450).

91. The computing device of any of claims 50 to 90, further comprising placing one or more tubes (582) from an other tube rack (580) within the rotor (450) prior to placing the plurality of tubes (572) from the tube rack (570) within the rotor (450) if a count of the one or more tubes (582) in the other tube rack (580) is less than a count of the plurality of tubes (572) in the tube rack (570).
